(19) United States
(12) Patent Application Publication
(10) Pub. No.: US 2016/0165220 A1
(43) Pub. Date: Jun. 9, 2016

(54) DISPLAY APPARATUS AND METHOD OF CONTROLLING DISPLAY APPARATUS

(71) Applicant: SEIKO EPSON CORPORATION, Tokyo (JP)

(72) Inventors: Yutaka FUJIMAKI, Matsumoto-shi (JP); Kenro YAJIMA, Matsumoto-shi (JP); Yuichi MORI, Minowa-machi (JP)

(73) Assignee: SEIKO EPSON CORPORATION, Tokyo (JP)

(21) Appl. No.: 14/960,791

(22) Filed: Dec. 7, 2015

(30) Foreign Application Priority Data
Dec. 8, 2014 (JP) 2014-247963
Oct. 30, 2015 (JP) 2015-213656

(51) Int. Cl. H04N 13/04; G09G 3/36; G02B 27/01; H04N 5/374

(52) U.S. Cl. CPC H04N 13/044; H04N 13/0459; H04N 13/0497; H04N 5/374; H04N 13/0484; G09G 3/36; G02B 27/017

(57) ABSTRACT

A display apparatus includes a display unit, a plurality of sensors, a first control unit that controls the display apparatus, a second control unit that is connected to the plurality of sensors and transmits data including detection results of the plurality of sensors to the first control unit.

### BACKGROUND

1. Technical Field

The present invention relates to a display apparatus and a method of controlling a display apparatus.

2. Related Art

In the related art, a display apparatus that is provided with various sensors along with a display unit is known (see JP-A-2013-114160, for example). According to such a display apparatus, detection values of the sensors are used for controlling display in some cases. For example, the display apparatus disclosed in JP-A-2013-114160 is provided with a sensor unit, a signal that indicates a result of sensing by the sensor unit and a signal that indicates interruption are input to a control unit of a control device, and the control unit controls display based on the result of the sensing.

Incidentally, sampling cycles and data amounts of detection values variously change depending on types of sensors. Therefore, it is necessary for the control unit to obtain detection values in accordance with specifications of connected sensors, and a burden increases as the types and the numbers of the sensors increase. In addition, there is also a possibility that connection of a large number of sensors to the control unit complicates a circuit configuration.

### SUMMARY

An advantage of some aspects of the invention is to reduce a processing burden on a control unit that uses detection results of sensors and avoid complication of a circuit configuration in a display apparatus that is provided with sensors.

An aspect of the invention is directed to a display apparatus including: a display unit; a plurality of sensors; a first control unit that controls the display apparatus; and a second control unit that is connected to the plurality of sensors and transmits data including detection results of the plurality of sensors to the first control unit.

According to the aspect of the invention, the second control unit that is connected to the plurality of sensors transmits the data including the detection results of the sensors to the first control unit that controls the display apparatus. Therefore, it is not necessary for the first control unit to directly control the sensors. For this reason, it is possible to execute control in accordance with differences in specifications and properties of the sensors, for example, by the second control unit without increasing the burden on the first control unit that controls the display apparatus. Therefore, it is possible to reduce the processing burden of the first control unit, to reduce power consumption by the first control unit, and to increase a processing speed of the first control unit. In addition, it is possible to avoid complication of a circuit configuration including the first control unit.

In the aspect of the invention, the second control unit may collectively control the plurality of sensors based on control by the first control unit.

According to the aspect of the invention with this configuration, it is possible to perform control on a large number of sensors and to perform detailed control thereon without increasing the burden on the first control unit.

In the aspect of the invention, the second control unit may obtain the detection results of the plurality of sensors at a plurality of different sampling cycles.

According to the aspect of the invention with this configuration, the first control unit can obtain the detection results of the plurality of sensors with different sampling cycles, and the processing burden of the first control unit for obtaining the results of the detection can be reduced.

In the aspect of the invention, the second control unit may obtain the detection results of the plurality of sensors at a first sampling cycle and a second sampling cycle that is longer than the first sampling cycle, and transmit data including the detection results of the sensors, which are obtained at the first sampling cycle, and the detection results of the sensors, which are obtained at the second sampling cycle, to the first control unit.

According to the aspect of the invention with this configuration, the first control unit can obtain the detection results of the plurality of sensors with different sampling cycles, and the processing burden of the first control unit for obtaining the results of the detection can be reduced.

In the aspect of the invention, the second control unit may be able to transmit the data including the detection results of the sensors to the first control unit in any of a first transmission format corresponding to the first sampling cycle and a second transmission format corresponding to the second sampling cycle.

According to the aspect of the invention with this configuration, the second control unit that is connected to the sensors transmits the data including the detection results of the sensors in transmission formats corresponding to the sampling cycles. Therefore, it is possible to obtain the detection results of the sensors and to transmit the data including the results of the detection at a sampling cycle suitable for each sensor.

In the aspect of the invention, the second control unit may select any of the first transmission format and the second transmission format and transmit the data including the detection results of the sensors based on a sampling cycle that is requested by the first control unit.

According to the aspect of the invention with this configuration, it is possible to obtain the results of the detection at the requested sampling cycle and to transmit the data including the results of the detection in the transmission format suitable for the sampling cycle.

In the aspect of the invention, between the first control unit and the second control unit, transmission synchronization processing of synchronizing timing at which the second control unit transmits the data to the first control unit and setting of the data to be transmitted from the second control unit to the first control unit may be performed.

According to the aspect of the invention with this configuration, it is possible to efficiently perform data processing by the second control unit that transmits the data including the detection results of the sensors and the first control unit that processes the data including the detection results of the sensors being synchronized.

In the aspect of the invention, the display apparatus may further include a sensor information storage unit that is connected to the second control unit and stores information related to the sensors that are connected to the second control unit, and the first control unit may set the data to be transmitted by the second control unit based on the information that is stored in the sensor information storage unit.

According to the aspect of the invention with this configuration, it is possible to perform setting in accordance with properties and specifications, for example, of the sensors since the data including the detection results of the sensors is set by using the information related to the sensors.

In the aspect of the invention, the sensor information storage unit may store information including sensor identifiers for identifying the sensors and sampling cycles at which the detection results of the sensors are obtained in association with the sensors.

According to the aspect of the invention with this configuration, it is possible to identify sensors and to obtain the results of the detection at the sampling cycles corresponding to the respective sensors.

In the aspect of the invention, the sensor information storage unit may store information that indicates processing to be executed by the second control unit in association with the sensors.

According to the aspect of the invention with this configuration, it is possible to designate the processing to be executed in association with the sensors by information that is stored in advance.

In the aspect of the invention, the first control unit may transmit a control signal to the second control unit, and the second control unit may initialize the sensors that are connected to the second control unit when the second control unit receives a control signal for instructing initialization from the first control unit.

According to the aspect of the invention with this configuration, it is possible to initialize the sensors by using the control signal as a trigger.

In the aspect of the invention, the second control unit may execute synchronization processing with the first control unit when the second control unit receives the control signal for instructing initialization from the first control unit and initializes the sensors, and transmit the detection results of the sensors, which are obtained later, with data of detection time to the first control unit.

According to the aspect of the invention with this configuration, the first control unit and the second control unit can initialize the sensors in a synchronized manner by using the control signal as a trigger. In doing so, it is possible to perform processing on the data including the detection results of the sensors while the detection timing is taken into consideration.

In the aspect of the invention, the display apparatus may further include: a transmission unit that is connected to the first control unit and transmits the control signal as an optical signal; and a receiving unit that is connected to the second control unit and receives the optical signal that is transmitted by the transmission unit.

According to the aspect of the invention with this configuration, it is possible to suppress a delay caused during exchange of the control signal by using the optical signal.

In the aspect of the invention, the display apparatus may further include: a first GPS receiving unit that is connected to the first control unit and obtains time information based on a GPS signal; and a second GPS receiving unit that is connected to the second control unit and obtains time information based on a GPS signal, and the first control unit and the second control unit may execute synchronization processing based on the time information that is respectively obtained by the first GPS receiving unit and the second GPS receiving unit.

According to the aspect of the invention with this configuration, it is possible to synchronize the first control unit and the second control unit by using the GPS signals.

In the aspect of the invention, the second control unit may initialize the sensors that are connected to the second control unit when the second control unit receives the control signal for requesting setting update from the first control unit.

According to the aspect of the invention with this configuration, it is possible to initialize the sensors by the control of the first control unit.

In the aspect of the invention, in the synchronization processing, the first control unit may transmit a synchronization signal to the second control unit at a predetermined timing, and the second control unit may perform the synchronization based on the synchronization signal that is transmitted by the first control unit.

According to the aspect of the invention with this configuration, it is possible to synchronize the first control unit and the second control unit by exchanging the synchronization signal.

In the aspect of the invention, after the execution of the synchronization processing, the first control unit and the second control unit may respectively execute counting of time codes, and the second control unit may transmit the data that is obtained by adding the time codes indicating acquisition time to the obtained results of the detection when the second control unit obtains the detection results of the sensors.

According to the aspect of the invention with this configuration, it is possible to exchange the time at which the results of the detection are obtained by exchanging the data including the detection results of the sensors.

In the aspect of the invention, the second control unit may create the data by embedding the time codes indicating the acquisition time in the data of the obtained results of the detection when the second control unit obtains the detection results of the sensors or adding the time code to the results of the detection, and transmit the data.

According to the aspect of the invention with this configuration, it is possible to enhance the efficiency of the processing related to the exchange of the data by embedding the time codes in the data including the detection results of the sensors.

In the aspect of the invention, the second control unit may execute predetermined processing that is set in advance based on the detection results of the sensors when the second control unit receives a command from the first control unit.

According to the aspect of the invention with this configuration, it is possible to further reduce the processing burden of the first control unit since the second control unit that obtains the detection values of the sensors executes the processing based on the detection results of the sensors.

In the aspect of the invention, the second control unit may execute, as the predetermined processing, processing of changing a display state of the display unit in accordance with an environment of the display unit based on the detection results of the sensors.

According to the aspect of the invention with this configuration, it is possible to execute the processing of changing the display state in accordance with the environment of the display unit without increasing the burden on the first control unit.

In the aspect of the invention, the second control unit may be connected to a setting data storage unit that stores setting data and execute the predetermined processing by using the setting data that is stored in the setting data storage unit.

According to the aspect of the invention with this configuration, the second control unit that obtains the detection values of the sensors can change the display state based on the setting data.

Here, the setting data storage unit that stores the setting data may be integrally provided with the second control unit or may be provided inside the second control unit.

In the aspect of the invention, the second control unit may hold the results of the detection obtained from the sensors until the results of the detection are transmitted to the first control unit.

According to the aspect of the invention with this configuration, it is possible to further reduce the processing burden since the first control unit can execute the processing without being restricted by the timing at which the second control unit obtains the detection results of the sensors.

In the aspect of the invention, the second control unit may execute, based on a detection result of any of the sensors, processing on detection results of the other sensors, and transmit the results of the detection after the processing to the first control unit.

According to the aspect of the invention with this configuration, it is possible to correct the detection results of the other sensors based on the detection results of the sensor and to perform processing such as sensor fusion.

In the aspect of the invention, the display apparatus may further include: a first main body that includes the first control unit; and a second main body that includes the second control unit and the display unit, and the second control unit is connected to the plurality of sensors that are provided in the second main body, the first main body may be provided with a sensor, and the sensor provided in the first main body may be connected to the first control unit, and the first control unit may calculate characteristic values based on detection results and positions of the sensors in the second main body and a detection result and a position of the sensor in the first main body.

According to the aspect of the invention with this configuration, the first control unit can obtain the characteristic values by using the detection result of the sensor in the first main body that includes the first control unit and the detection results of the sensors in the second main body that includes the display unit, and the burden on the first control unit in relation to the calculation of the characteristic values can be reduced.

In the aspect of the invention, the display apparatus may further include: a first main body that includes the first control unit and the display unit; and a second main body that includes the second control unit, and the second control unit may be connected to the plurality of sensors that are provided in the second main body, the first main body may be provided with a sensor, and the sensor that may be provided in the first main body is connected to the first control unit, and the first control unit may perform control based on detection results of the sensor in the first main body and the sensors in the second main body.

According to the aspect of the invention with this configuration, the first control unit that is provided along with the display unit in the first main body can obtain the detection results of the sensors in the second main body, and a burden of the processing of obtaining the detection results of the sensors in the second main body can be reduced.

Another aspect of the invention is directed to a method of controlling a display apparatus including: controlling a display apparatus that is provided with a display unit, a plurality of sensors, a first control unit, and a second control unit; causing the second control unit that is connected to the plurality of sensors to collectively control the plurality of sensors; and transmitting data including detection results of the plurality of sensors to the first control unit that controls the display apparatus.

According to the aspect of the invention, it is not necessary for the first control unit that controls the display apparatus to directly control the sensors, and the second control unit can execute control in accordance with differences in specifications and properties, for example, of the sensors without increasing the burden on the first control unit. Therefore, it is possible to reduce the processing burden of the first control unit, to reduce power consumption of the first control unit, and to increase a processing speed of the first control unit. In addition, it is possible to avoid complication of a circuit configuration including the first control unit.

### BRIEF DESCRIPTION OF THE DRAWINGS

The invention will be described with reference to the accompanying drawings, wherein like numbers reference like elements.

FIG. 1 is an explanatory diagram of an appearance configuration of a head-mounted display apparatus according to a first embodiment.

FIG. 2 is a diagram illustrating a configuration of an optical system in an image display unit.

FIG. 3 is a functional block diagram of the respective components in the head-mounted display apparatus.

FIGS. 4A and 4B are flowcharts illustrating operations of the head-mounted display apparatus, where FIG. 4A illustrates operations of a control device, and FIG. 4B illustrates operations of an image display unit.

FIGS. 5A and 5B are flowcharts illustrating operations of the head-mounted display apparatus, where FIG. 5A illustrates operations of the control device, and FIG. 5B illustrates operations of the image display unit.

FIGS. 6A and 6B are flowcharts illustrating operations of the head-mounted display apparatus, where FIG. 6A illustrates operations of the control device, and FIG. 6B illustrates operations of the image display unit.

FIGS. 7A and 7B are flowcharts illustrating operations of a head-mounted display apparatus according to a second embodiment, where FIG. 7A illustrates operations of a control device, and FIG. 7B illustrates operations of an image display unit.

FIG. 8 is a diagram schematically illustrating a configuration example of sensor data that is stored in the image display unit.

FIG. 9 is a diagram schematically illustrating an example of a transmission format of data that is transmitted from the image display unit to the control device.

FIGS. 10A and 10B are flowcharts illustrating operations of the head-mounted display apparatus, where FIG. 10A illustrates operations of the control device, and FIG. 10B illustrates operations of the image display unit.

FIG. 11 is a functional block diagram of the respective components in a head-mounted display apparatus according to a third embodiment.

FIG. 12 is an explanatory diagram illustrating an appearance configuration of a communication system according to a fourth embodiment.

FIG. 13 is a functional block diagram of the respective components in the communication system according to the fourth embodiment.

### DESCRIPTION OF EXEMPLARY EMBODIMENTS

### First Embodiment

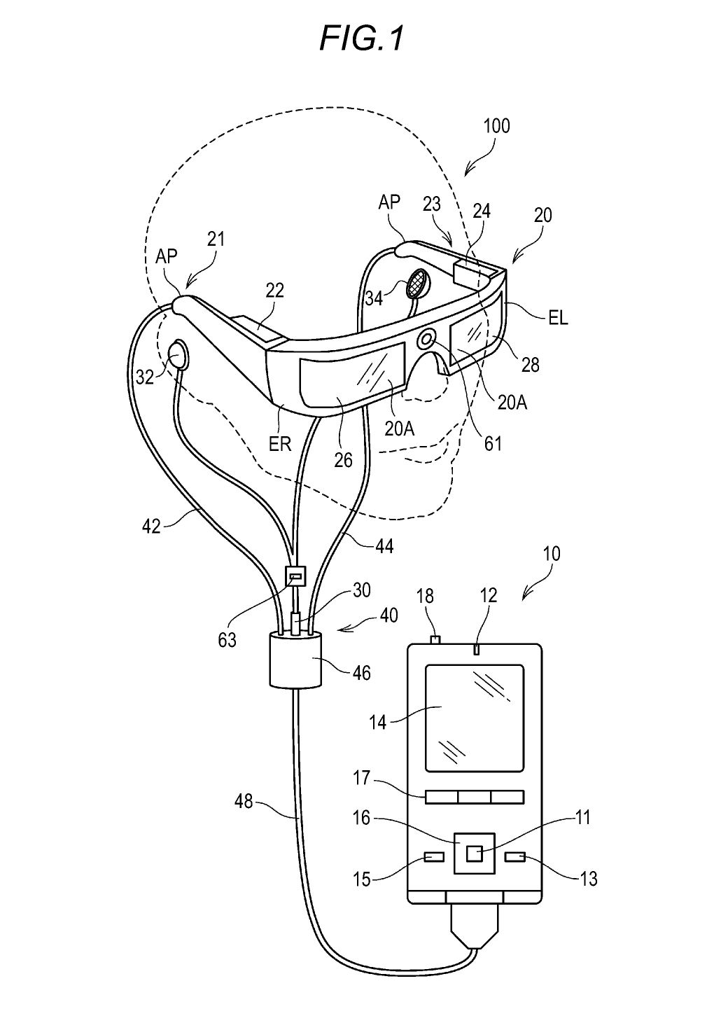

FIG. 1 is an explanatory diagram illustrating an appearance configuration of a head-mounted display apparatus 100 (display apparatus) according to a first embodiment to which the invention is applied.

The head-mounted display apparatus 100 includes an image display unit 20 (display unit) that causes a user to visually recognize a virtual image in a state in which the user wears the head-mounted display apparatus 100 on their head and a control device 10 that controls the image display unit 20. The control device 10 also functions as a controller by which the user operates the head-mounted display apparatus 100.

The image display unit 20 is a mounted body that is mounted on the head of the user and has a form of glasses in this embodiment. The image display unit 20 includes a right holding unit 21, a right display drive unit 22, a left holding unit 23, a left display drive unit 24, a right optical image display unit 26, a left optical image display unit 28, a camera 61 (imaging unit), and a microphone 63. The right optical image display unit 26 and the left optical image display unit 28 are respectively arranged so as to be positioned in front of right and left eyes of the user when the user wears the image display unit 20. One end of the right optical image display unit 26 and one end of the left optical image display unit 28 are coupled to each other at a position corresponding to a position between eyebrows of the user when the user wears the image display unit 20.

The right holding unit 21 is a member that extends from an end ER corresponding to the other end of the right optical image display unit 26 to a position corresponding to a side of the head of the user when the user wears the image display unit 20. Similarly, the left holding unit 23 is a member that extends from an end EL corresponding to the other end of the left optical image display unit 28 to a position corresponding to a side of the head of the user when the user wears the image display unit 20. The right holding unit 21 and the left holding unit 23 hold the image display unit 20 at the head of the user while acting like temples of glasses.

The right display drive unit 22 and the left display drive unit 24 are arranged on sides on which the right display drive unit 22 and the left display drive unit 24 face the head of the user when the user wears the image display unit 20. The right display drive unit 22 and the left display drive unit 24 will be collectively and simply referred to as a “display drive unit”, and the right optical image display unit 26 and the left optical image display unit 28 will be collectively and simply referred to as an “optical image display unit”.

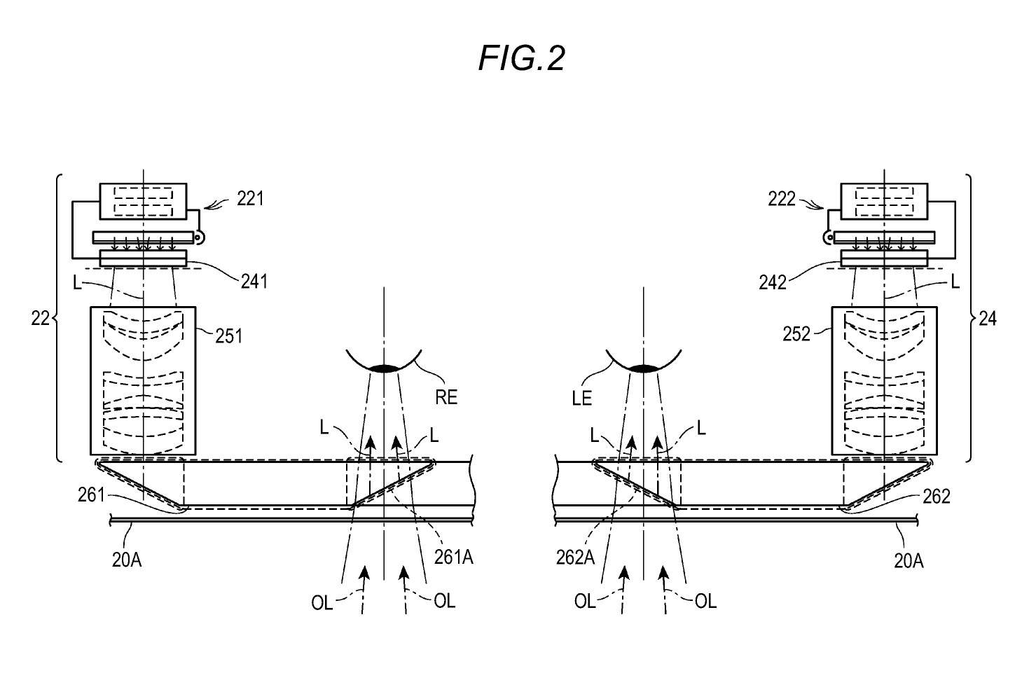

The display drive units 22 and 24 include liquid crystal displays 241 and 242 (hereinafter, referred to as “LCDs 241 and 242”), projection optical systems 251 and 252, and the like which will be described later with reference to FIG. 2.

The right optical image display unit 26 and the left optical image display unit 28 include light guiding plates 261 and 262 (FIG. 2) and a photochromatic plate 20A. The light guiding plates 261 and 262 are formed of light transmitting resin, for example, and guide image light that is output by the display drive units 22 and 24 to eyes of the user. The photochromatic plate 20A is a thin-plate optical element and is arranged so as to cover a front side of the image display unit 20 on an opposite side to the side of the eyes of the user. As the photochromatic plate 20A, various kinds of photochromatic plates such as a photochromatic plate with substantially no light transmission, a photochromatic plate that is almost transparent, a photochromatic plate that attenuates light intensity and transmits light, or a photochromatic plate that attenuates or reflects light with a specific wavelength can be used. By appropriately selecting optical properties (light transmittance and the like) of the photochromatic plate 20A, it is possible to adjust the intensity of outside light that is incident from the outside to the right optical image display unit 26 and the left optical image display unit 28 and to adjust how easily the user can visually recognize the virtual image. In this embodiment, a description will be given of a case in which the photochromatic plate 20A that has at least such light transmittance that the user who wears the head-mounted display apparatus 100 can visually recognize an outside view is used. The photochromatic plate 20A protects the right light guiding plate 261 and the left light guiding plate 262 and suppresses damage, contamination, and the like of the right light guiding plate 261 and the left light guiding plate 262.

The photochromatic plate 20A may be detachable from the right optical image display unit 26 and the left optical image display unit 28, a plurality of kinds of photochromatic plates 20A may be replaced and mounted, or the photochromatic plate 20A may be omitted.

The camera 61 is arranged at a boundary between the right optical image display unit 26 and the left optical image display unit 28. The position of the camera 61 is substantially the center of the eyes of the user in the horizontal direction and above the eyes of the user in the vertical direction in the state in which the user wears the image display unit 20. The camera 61 is a digital camera that is provided with an imaging element, such as a CCD or a CMOS, and an imaging lens, for example, and may be a monocular camera or a stereo camera.

The camera 61 images at least a part of an outside view in a direction of the front side of the head-mounted display apparatus 100, in other words, in a direction of eyesight of the user in the state in which the user wears the head-mounted display apparatus 100. Although the field of view of the camera 61 can be appropriately set, the field of view is preferably within such a range that an imaging range of the camera 61 includes the outside world that the user visually recognizes through the right optical image display unit 26 and the left optical image display unit 28. Furthermore, it is more preferable that the imaging range of the camera 61 is set so as to be able to image the entire eyesight of the user through the photochromatic plate 20A.

FIG. 2 is a plan view of main parts that illustrates a configuration of an optical system in the image display unit 20. FIG. 2 illustrates a left eye LE and a right eye RE of the user for explanation.

The left display drive unit 24 is provided with a left backlight 222 that includes a light source such as an LED and a diffuser plate. In addition, the left display drive unit 24 includes a left projection optical system 252 that includes a transmission-type left LCD 242 arranged on an optical path of light that is diffused by the diffuser plate of the left backlight 222 and a lens group for guiding image light L that is transmitted through the left LCD 242, for example. The left LCD 242 is a transmission-type liquid crystal panel in which a plurality of pixels are arranged in a matrix form.

The left projection optical system 252 includes a collimator lens that collects the outgoing image light L from the left LCD 242 as a light flux in a parallel state. The image light L collected as the light flux in the parallel state by the collimator lens is incident on the left light guiding plate 262 (optical element). The left light guiding plate 262 is a prism in which a plurality of reflective surfaces that reflect the image light L are formed, and the image light L is guided to the side of the left eye LE after being reflected a plurality of times in the left light guiding plate 262. A half mirror 262A (reflective surface) that is positioned in front of the left eye LE is formed at the left light guiding plate 262.

The image light L that is reflected by the half mirror 262A is output from the left optical image display unit 28 toward the left eye LE, and the image light L forms an image at a retina of the left eye LE and causes the user to visually recognize the image.

The right display drive unit 22 is formed so as to be horizontally symmetrical with the left display drive unit 24. The right display drive unit 22 includes a right backlight 221 that includes a light source such as an LED and a diffuser plate. In addition, the right display drive unit 22 includes a right projection optical system 251 that includes a transmission-type right LCD 241 arranged on an optical path of light that is diffused by the diffuser plate of the right backlight 221 and a lens group that guides the image light L transmitted through the right LCD 241, for example. The right LCD 241 is a transmission-type liquid crystal panel in which a plurality of pixels are arranged in a matrix form.

The right projection optical system 251 includes a collimator lens that collects the outgoing image light L from the right LCD 241 as a light flux in a parallel state. The image light L that is collected as the light flux in the parallel state by the collimator lens is incident on the right light guiding plate 261 (optical element). The right light guiding plate 261 is a prism in which a plurality of reflective surfaces that reflect the image light L are formed, and the image light L is guided to the side of the right eye RE after being reflected a plurality of times inside the right light guiding plate 261. A half mirror 261A (reflective surface) that is positioned in front of the right eye RE is formed at the right light guiding plate 261.

The image light L that is reflected by the half mirror 261A is output from the right optical image display unit 26 toward the right eye RE, and the image light L forms an image at a retina of the right eye RE and causes the user to visually recognize the image.

The image light L that is reflected by the half mirror 261A and outside light OL that is transmitted through the photochromatic plate 20A are incident on the right eye RE of the user. The image light L that is reflected by the half mirror 262A and the outside light OL that is transmitted through the photochromatic plate 20A are incident on the left eye LE. The head-mounted display apparatus 100 causes the image light L of an internally processed image and the outside light OL to be incident on the eyes of the user in an overlapped manner as described above, and the user can see the outside view through the photochromatic plate 20A and visually recognize the image formed by the image light L in an overlapped manner with the outside view. The head-mounted display apparatus 100 functions as a see-through-type display apparatus as described above.

The left projection optical system 252 and the left light guiding plate 262 will be collectively referred to as a “left light guiding unit”, and the right projection optical system 251 and the right light guiding plate 261 will be collectively referred to as a “right light guiding unit”. The configurations of the right light guiding unit and the left light guiding unit are not limited to the aforementioned example, and an arbitrary scheme can be used as long as a virtual image can be formed in front of the eyes of the user by using image light. For example, diffraction grating or a semi-transparent reflective film may be used.

The image display unit 20 (FIG. 1) is connected to the control device 10 via a connection unit 40. The connection unit 40 is a harness that includes a main code 48 that is connected to the control device 10, a right code 42, a left code 44, and a coupling member 46. The right code 42 and the left code 44 are formed by branching the main code 48 into two parts, and the right code 42 is inserted into a case body of the right holding unit 21 from a tip end AP of the right holding unit 21 in an extending direction and is then connected to the right display drive unit 22. Similarly, the left code 44 is inserted into a case body of the left holding unit 23 from a tip end AP of the left holding unit 23 in an extending direction and is then connected to the left display drive unit 24. Any codes can be used as the right code 42, the left code 44, and the main code 48 as long as the codes can transmit digital data, and the right code 42, the left code 44, and the main code 48 can be formed of metal cables or an optical fiber, for example. Alternatively, a configuration is also applicable in which the right code 42 and the left code 44 are integrally formed as a single code.

The coupling member 46 is provided at a branching point of the right code 42 and the left code 44 from the main code 48 and includes a jack for connecting an earphone plug 30. A right earphone 32 and a left earphone 34 extend from the earphone plug 30. The microphone 63 is provided in the vicinity of the earphone plug 30. A single code is provided from the earphone plug 30 to the microphone 63, the microphone 63 is then branched from the code, and the earphone plug 30 is connected to a right earphone 32 and a left earphone 34, respectively.

The microphone 63 is arranged such that a sound collecting unit of the microphone 63 is directed in a visual line direction of the user as illustrated in FIG. 1, for example, collects sound, and outputs a sound signal. The microphone 63 may be a monaural microphone, a stereo microphone, a microphone with directionality, or a microphone with no directionality.

The image display unit 20 and the control device 10 transmit various signals via the connection unit 40. An end of the main code 48 on the opposite side to the coupling member 46 and the control device 10 are provided with connectors that are fitted to each other (not shown). It is possible to connect and separate the control device 10 and the image display unit 20 by fitting the connector of the main code 48 and the connector of the control device 10 or releasing the fitting therebetween.

The control device 10 includes a box-shaped main body (first main body) that is separate from a main body (second main body) of the image display unit 20 and controls the head-mounted display apparatus 100. The control device 10 includes various switches including a decision key 11, a lighting unit 12, a display switching key 13, a luminance switching key 15, a direction key 16, a menu key 17, and a power switch 18. In addition, the control device 10 includes a track pad 14 that the user operates with their fingers.

The decision key 11 detects a pressing operation and outputs a signal for deciding content of an operation by the control device 10. The lighting unit 12 includes a light source such as a light emitting diode (LED) and provides notification about an operation state (ON/OFF states of the power source, for example) of the head-mounted display apparatus 100 by changing a lighting state of the light source. The display switching key 13 outputs a signal for instructing switching of an image display mode, for example, in response to a pressing operation.

The track pad 14 includes an operation surface that detects a contact operation and outputs an operation signal in response to an operation performed on the operation surface. A detection method on the detection surface is not limited, and an electrostatic scheme, a pressure detection scheme, an optical scheme, or the like can be employed. The luminance switching key 15 outputs a signal for instructing an increase or a decrease of luminance of the image display unit 20 in response to a pressing operation. The direction key 16 outputs an operation signal in response to a pressing operation performed on a key corresponding to vertical or horizontal directions. The power switch 18 is a switch for switching ON/OFF states of the power source of the head-mounted display apparatus 100.

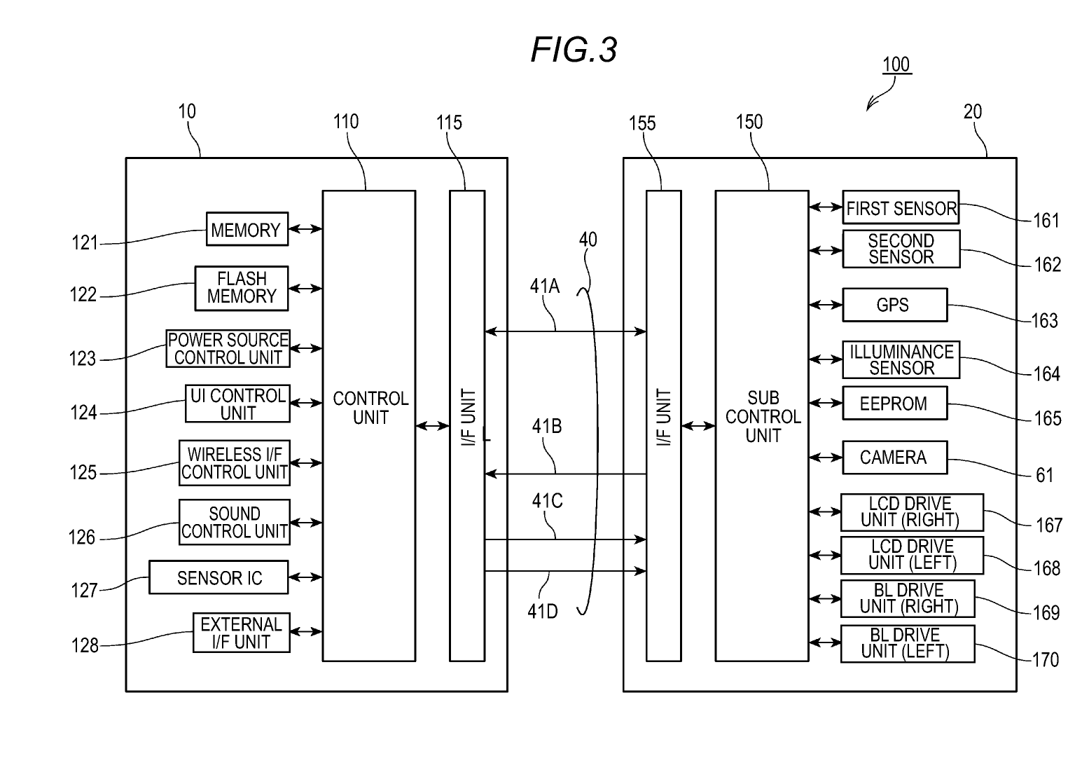

FIG. 3 is a functional block diagram of the respective components in the head-mounted display apparatus 100.

The control device 10 includes a control unit 110 (first control unit) that controls the control device 10 and the image display unit 20. The control unit 110 is formed of a microprocessor, for example, and is connected to a memory 121 that temporarily stores data to be processed by the control unit 110 and a flash memory 122 that stores, in a non-volatile manner, data to be processed by the control unit 110. Both the memory 121 and the flash memory 122 are formed of semiconductor elements and are connected to the control unit 110 via a data bus.

A power source control unit 123, a user interface (UI) control unit 124, a wireless interface (I/F) control unit 125, a sound control unit 126, a sensor IC 127, and an external interface (I/F) unit 128 are connected to the control unit 110.

The head-mounted display apparatus 100 is provided with a primary battery or a secondary battery as a power source, and the power source control unit 123 is formed of an IC that is connected to the battery. The power source control unit 123 is controlled by the control unit 110 to detect the remaining capacity of the battery and outputs data of the detection value or data that indicates that the remaining capacity falls below a setting value to the control unit 110.

The UI control unit 124 is an IC to which various operation units including the decision key 11, the display switching key 13, the track pad 14, the luminance switching key 15, the direction key 16, the menu key 17, the lighting unit 12, and the track pad 14 illustrated in FIG. 1 are connected. The respective operation units function as input units, the lighting unit 12 and the track pad 14 function as output units, and the input units and the output units form a user interface of the head-mounted display apparatus 100. The UI control unit 124 detects an operation performed on the operation unit and outputs operation data corresponding to the operation to the control unit 110. In addition, the UI control unit 124 is controlled by the control unit 110 to turn on/off the lighting unit 12 and perform display on the track pad 14.

The wireless I/F control unit 125 is a control IC that is connected to a wireless communication interface (not shown) and is controlled by the control unit 110 to execute communication by the wireless communication interface. The wireless communication interface provided in the control device 10 executes wireless data communication in conformity with a standard such as a wireless LAN (WiFi (registered trademark)), Miracast (registered trademark), or Bluetooth (registered trademark).

The sound control unit 126 is an IC that is connected to the right earphone 32, the left earphone 34, and the microphone 63 and includes an analog/digital (A/D) converter, an amplifier, and the like. The sound control unit 126 causes the right earphone 32 and the left earphone 34 to output sound based on sound data that is input from the control unit 110. In addition, the sound control unit 126 creates sound data based on sound that is collected by the microphone 63 and outputs the sound data to the control unit 110.

The sensor IC 127 includes a three-axis acceleration sensor, a three-axis gyro sensor, and a three-axis geomagnetic sensor and is formed of a single IC that is provided with the aforementioned sensors, for example. The sensor IC 127 is controlled by the control unit 110 to execute detection and outputs data that indicates detection values of the respective sensors to the control unit 110. The number and the type of the sensors provided in the sensor IC 127 are not limited, and an illuminance sensor, a temperature sensor, a pressure sensor, and the like may be provided.

The external I/F unit 128 is an interface that connects the head-mounted display apparatus 100 to an external device. For example, an interface that is compatible with wired connection, such as a USB interface, a micro USB interface, or a memory card interface, can be used, and the external I/F unit 128 may be formed of a wireless communication interface. Various external devices that supply content to the head-mounted display apparatus 100 can be connected to the external I/F unit 128. These external devices can be regarded as image supply devices that supply images to the head-mounted display apparatus 100, and for example, a personal computer (PC), a mobile phone terminal, or a mobile game machine is used. In addition, the external I/F unit 128 may be provided with a terminal that is connected to the right earphone 32, the left earphone 34, and the microphone 63, and in such a case, an analog sound signal processed by the sound control unit 126 is input and output via the external I/F unit 128.

An interface (I/F) unit 115 is connected to the control unit 110. The I/F unit 115 is an interface that is provided with a connector to be connected to an end of the connection unit 40, and the other end of the connection unit 40 is connected to an I/F unit 155 of the image display unit 20.

The control unit 110 executes data communication with a sub-control unit 150, which is provided in the image display unit 20, via the connection unit 40.

The control unit 110 controls various components in the head-mounted display apparatus 100 by executing a program that is stored in a built-in ROM. The control unit 110 obtains detection values of the sensors based on data that is input by the sensor IC 127 and stores the detection values in the memory 121. At this time, the control unit 110 adds time stamp information that indicates a time at which the detection values are obtained and stores the time stamp information in association with the detection values of the sensors.

In addition, the control unit 110 receives data that indicates detection values of the sensors (a first sensor 161, a second sensor 162, a GPS 163, and an illuminance sensor 164) that are provided in the image display unit 20 via the connection unit 40. The control unit 110 stores the received data in the memory 121. The data that is received by the control unit 110 includes the time stamp information that is added by the sub-control unit 150. The control unit 110 adds the time stamp information, which is to be added to the detection values of the sensor IC 127 as described above, in a form in which the time stamp information can be distinguished from the time stamp information that is added by the sub-control unit 150, and stores the time stamp information to be added to the detection values of the sensor IC 127 in the memory 121. The memory 121 stores the detection values of the sensors in a data format to which time stamp information is added as one of attributes of the data. Here, the control unit 110 stores the data of the detection values of the sensors in the flash memory 122.

The control unit 110 receives data of content from an external device that is connected by the external I/F unit 128 or the wireless I/F control unit 125 and stores the data of content in the flash memory 122. The data of content is data of texts, images, and the like to be displayed by the image display unit 20 and may include data of sound to be output by the right earphone 32 and the left earphone 34. The control unit 110 controls the head-mounted display apparatus 100 and reproduces the content. Specifically, the control unit 110 transmits display data of content to the sub-control unit 150, causes the sub-control unit 150 to execute display, outputs sound data of the content to the sound control unit 126, and causes the sound control unit 126 to output the sound. If data of content that is received from the external device includes data that indicates conditions related to reproduction, the control unit 110 reproduces the content in accordance with the conditions. If detection values of the sensors, such as positions and inclination, meet the conditions, for example, the image display unit 20 is made to display texts and images corresponding to the detection values.

The image display unit 20 includes the sub-control unit 150 that executes communication with the control unit 110 and controls various components in the image display unit 20. The sub-control unit 150 is formed of a microprocessor such as a microcomputer or a system-on-a-chip (SoC), is connected to the connection unit 40 by the I/F unit 155, and executes data communication with the control unit 110 via the connection unit 40. The sub-control unit 150 may include a read only memory (ROM) that stores, in a non-volatile manner, a control program to be executed by the processor and a random access memory (RAM) that forms a work area as well as the processor. The sub-control unit 150 executes a program that is stored in the built-in ROM or an EEPROM 165, which will be described later, and realizes various functions.

Sensors such as the first sensor 161, the second sensor 162, the GPS 163, and the illuminance sensor 164 are connected to the sub-control unit 150. The first sensor 161 and the second sensor 162 are ICs, each of which includes one or more built-in sensors. In this exemplary embodiment, the first sensor 161 includes a built-in three-axis acceleration sensor and a built-in three-axis gyro sensor, and the second sensor 162 includes a three-axis acceleration sensor, a three-axis gyro sensor, and a three-axis geomagnetic sensor.

The first sensor 161 and the second sensor 162 are controlled and driven by the sub-control unit 150 and outputs data that indicates detection values of the respective built-in sensors to the sub-control unit 150.

Although the first sensor 161 and the second sensor 162 commonly include acceleration sensors and gyro sensors, the first sensor 161 is formed as a narrow-range high-resolution sensor, and the second sensor 162 is formed as a wide-range low-resolution sensor. That is, the acceleration sensor and the gyro sensor in the first sensor 161 have higher resolution and narrower detection ranges than those of the acceleration sensor and the gyro sensor in the second sensor 162. In other words, the acceleration sensor and the gyro sensor in the second sensor 162 have lower resolution and wider detection ranges than those of the acceleration sensor and the gyro sensor in the first sensor 161.

The GPS 163 receives a signal for position detection that is transmitted by a GPS satellite or a pseudo-GPS transmitter (not shown) installed indoors, calculates a present position of the image display unit 20, and outputs the calculated data to the sub-control unit 150. The GPS 163 may be configured to have only a function as a receiver that receives the signal for position detection, and in such a case, it is only necessary for the sub-control unit 150 to perform the processing of calculating the present position based on data that is output from the GPS 163.

The illuminance sensor 164 is arranged at a position, at which the illuminance sensor 164 is exposed to the front surface, of the image display unit 20, is controlled by the sub-control unit 150 to detect illuminance, and outputs data that indicates detection values to the sub-control unit 150.

The EEPROM 165 (setting data storage unit) stores, in a non-volatile manner, data related to processing to be executed by the sub-control unit 150.

In addition, the camera 61 is connected to the sub-control unit 150, and the sub-control unit 150 controls the camera 61 to capture images, and transmits captured image data of the camera 61 to the control unit 110.

An LCD drive unit 167 that drives the right LCD 241 to perform image depiction and an LCD drive unit 168 that drives the left LCD 242 to perform image depiction are connected to the sub-control unit 150. The sub-control unit 150 receives data of content from the control unit 110, creates display data for displaying texts and images included in the received data, outputs the display data to the LCD drive units 167 and 168, and causes the LCD drive units 167 and 168 to execute display.

In addition, the sub-control unit 150 is connected to a backlight drive unit 169 that drives the right backlight 221 and a backlight drive unit 170 that drives the left backlight 222. The sub-control unit 150 outputs control data including timing data for PWM control to the backlight drive units 169 and 170. The backlight drive units 169 and 170 supply drive voltages and pulses to the right backlight 221 and the left backlight 222 based on control data that is input from the sub-control unit 150, light the right backlight 221 and the left backlight 222, and control the light intensity.

The connection unit 40 that connects the control unit 110 and the sub-control unit 150 includes a plurality of data buses including a control data bus 41A, an image data bus 41B, and display data buses 41C and 41D. These data buses can independently transmit data and may be configured such that signal lines forming the respective data buses are physically separated, or the respective data buses may be virtually or logically configured by using a common signal line.

The control data bus 41A transmits data such as control data that is transmitted from the control unit 110 to the sub-control unit 150 and detection values of the sensors that are transmitted from the sub-control unit 150 to the control unit 110. The image data bus 41B transmits captured image data of the camera 61 from the sub-control unit 150 to the control unit 110. The display data bus 41C transmits data to be displayed by the right display drive unit 22, and the display data bus 41D transmits data to be displayed by the left display drive unit 24.

The image display unit 20 includes a plurality of sensors such as the first sensor 161, the second sensor 162, the GPS 163, and the illuminance sensor 164, and sampling cycles of these sensors greatly differ in some cases. For example, although it is considered that a sampling cycle (sampling frequency) of the acceleration sensors in the first sensor 161 and the second sensor 162 are equal to or greater than 200 times per second, a sampling cycle of the illuminance sensor 164 that is about once per second is considered to be sufficiently useful. The sub-control unit 150 sets the sampling cycles of these sensors, and the sub-control unit 150 obtains detection values in accordance with the set sampling cycles. The sub-control unit 150 transmits data of sampled detection values from the respective sensors to the control unit 110 through the control data bus 41A in a time division manner. Therefore, the control data bus 41A is not occupied for a long time for controlling a sensor with a late sampling cycle (in other words, a low sampling frequency or a long sampling cycle). In doing so, it is possible to reduce overhead of the control data bus 41A and to efficiently transmit detection values of a large number of sensors by the control data bus 41A. In addition, the sub-control unit 150 includes a built-in RAM (not shown), and in a case of obtaining detection values of the sensors, temporarily stores the detection values in the RAM. The sub-control unit 150 adjusts transmission timing of the data that is stored in the RAM and sends the data to the control data bus 41A. Therefore, operations of the sub-control unit 150 are not easily restricted by the sampling cycles of the respective sensors, and it is possible to prevent processing of the sub-control unit 150 from being occupied by the control of the sensors.

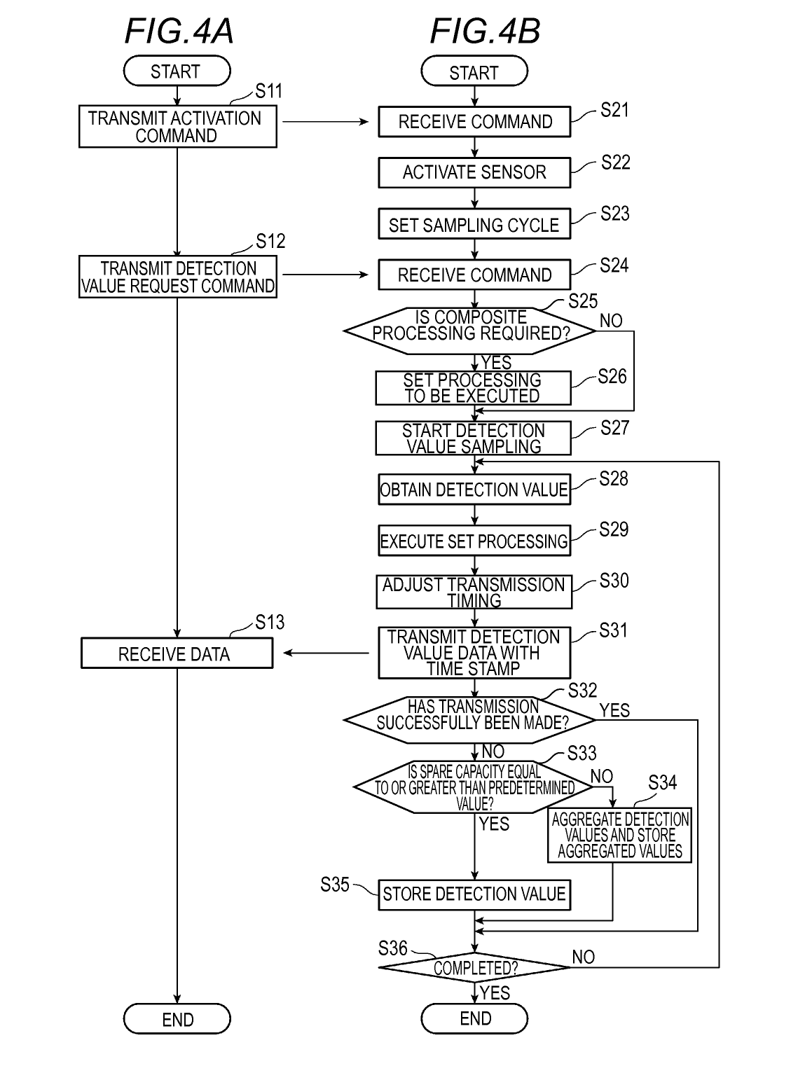

FIGS. 4A and 4B are flowcharts illustrating operations of the head-mounted display apparatus 100, where FIG. 4A illustrates operations of the control device 10, and FIG. 4B illustrates operations of the image display unit 20.

When the head-mounted display apparatus 100 executes processing based on detection values of the sensors, the control unit 110 creates a command for instructing activation of the sensors and transmits the command to the sub-control unit 150 (Step S11). The command is transmitted via the control data bus 41A and is received by the sub-control unit 150 (Step S21). The sub-control unit 150 activates the first sensor 161, the second sensor 162, the GPS 163, and the illuminance sensor 164 in response to the command (Step S22) and sets a sampling cycle for each of the sensors (Step S23). Then, the control unit 110 creates and transmits a detection value request command for designating a target sensor of detection or a type of a necessary detection value (Step S12), and the sub-control unit 150 receives the detection value request command (Step S24). In Step S22, processing such as start of power supply or initialization is performed on at least a part of the first sensor 161, the second sensor 162, the GPS 163, and the illuminance sensor 164. The sub-control unit 150 may activate only a sensor corresponding to the detection value that is requested by the detection value request command received in Step S24 from among the respective sensors after the reception in Step S24 and set a sampling cycle only for the sensor. Alternatively, the command that is transmitted in Step S11 and the detection value request command that is transmitted in Step S12 may be exchanged as a single piece of data or a single command.

The sub-control unit 150 determines whether or not the detection value that is requested by the detection value request command received in Step S24 is a detection value that is to be calculated by composite processing (Step S25). If the detection value request command designates detection values of the first sensor 161, the second sensor 162, the GPS 163, and the illuminance sensor 164, for example, the sub-control unit 150 determines that it is not necessary to perform the composite processing (Step S25: NO) and moves on to Step S27, which will be described later.

In contrast, if the detection value request command designates detection values obtained by computation processing based on detection values of a part or an entirety of the sensors provided in the image display unit 20, the sub-control unit 150 determines that it is necessary to perform the composite processing (Step S25: YES). In such a case, the sub-control unit 150 sets processing to be executed (Step S26) and moves on to Step S27.

The processing executed by the sub-control unit 150 includes sensor fusion processing, interpolation processing, and replacement processing. The sensor fusion processing is processing of artificially obtaining a value that cannot be directly detected by the sensors by performing computation processing using a plurality of detection values from among the detection values of the first sensor 161, the second sensor 162, the GPS 163, and the illuminance sensor 164. In doing so, it is possible to obtain a value that cannot be directly obtained by one of or a few of the first sensor 161, the second sensor 162, the GPS 163, and the illuminance sensor 164. The sensor fusion processing can also be used for the purpose of more precisely obtaining a value or values that can be directly detected by one or more of the sensors and can be output as a detection value or detection values. That is, it is possible to obtain a value with higher precision, which cannot be directly detected by the sensors, by the computation processing based on the detection values of the sensors. For example, it is possible to obtain a detection value of an angular velocity with a higher precision by performing the sensor fusion processing based on detection values of angular velocities that are output from the first sensor 161 and the second sensor 162. The same is true for acceleration detection values, geomagnetic detection values, and detection values of the GPS 163 and the illuminance sensor 164.

In the interpolation processing, the sub-control unit 150 performs computation processing of removing noise components and creating and adding interpolation data for any of the detection values of the first sensor 161, the second sensor 162, the GPS 163, and the illuminance sensor 164 by using detection values of other sensors. The sub-control unit 150 transmits values after the computation processing to the control unit 110 in the same manner as actual detection values. In such a case, since the amended detection values and the detection values interpolated in the computation processing are transmitted in the same manner as the actual detection values, the control unit 110 can execute processing in the same manner as the actual detection values. Therefore, it is possible to improve precision of processing without affecting the processing executed by the control unit 110.

The replacement processing is processing of artificially obtaining a detection value of a sensor that is out of order or does not operate normally from among the sensors provided in the image display unit 20 or a detection value of a sensor that is not provided in the image display unit 20 due to limitations of the specification.

For example, the sub-control unit 150 can obtain a detection value of an acceleration sensor at a center of a head or a face of the user who wears the image display unit 20. In such a case, the sub-control unit 150 performs computation based on detection values of the acceleration sensors in the first sensor 161 and the second sensor 162 and positions, at which the first sensor 161 and the second sensor 162 are attached, of the image display unit 20. In the computation, a positional relationship between the image display unit 20 and the head of the user may also be taken into consideration. In doing so, it is possible to obtain inclination of the center of the head or the face of the user, at which the user cannot actually wear the sensor. In addition, it is also possible to detect a tap operation of tapping the image display unit 20 based on the detection values of the acceleration sensors in the first sensor 161 and the second sensor 162 and to output the tap operation as a detection value of a tap sensor, for example.

Detection values obtained by the sensor fusion processing and the replacement processing are estimated values obtained by computation processing. The sub-control unit 150 may add attribute data, which indicates that the detection values are estimated values, to the obtained detection values and transmit the detection values to the control unit 110, or alternatively, the sub-control unit 150 may transmit the detection values in the same manner as data of actual detection values by other sensors.

In Step S27, the sub-control unit 150 starts processing of obtaining a detection value of a detection target sensor from among the first sensor 161, the second sensor 162, the GPS 163, and the illuminance sensor 164 (Step S27). The sub-control unit 150 obtains the detection value of the sensor at the sampling cycle that is set for each sensor in Step S23 (Step S28) and stores the detection value in the RAM.

If the processing based on a detection value is set in Step S26, the sub-control unit 150 executes the set processing (Step S29). If detection values of a plurality of sensors are required for executing the set processing, the sub-control unit 150 may wait for acquisition of the detection values of all the plurality of sensors and then execute the processing thereafter.

The sub-control unit 150 adjusts transmission timing at which the detection values of the sensors that are stored in the RAM are transmitted (Step S30) and transmits data of the setting values that are stored in the RAM to the control unit 110 at the adjusted timing (Step S31). Here, the sub-control unit 150 may transmit the data of the detection values with time stamp information that indicates detection time.

The control unit 110 receives the data that is transmitted by the sub-control unit 150 via the control data bus 41A (Step S13) and executes reproduction control of content based on the received data.

The sub-control unit 150 determines whether or not the data has been successfully transmitted to the control unit 110 (Step S32). If the data has been successfully transmitted (Step S32: YES), the processing proceeds to Step S36, which will be described later.

If the data has not been successfully transmitted to the control unit 110 (Step S32: NO), the sub-control unit 150 determines whether or not an available space of the RAM in the sub-control unit 150 is equal to or greater than a predetermined value (Step S33). Here, if the available space of the RAM is equal to or greater than the predetermined value that is set in advance (Step S33: YES), then the sub-control unit 150 continues to store the detection values (Step S35) and moves on to Step S36.

If the available space in the RAM is less than the predetermined value that is set in advance (Step S33: NO), then the sub-control unit 150 performs aggregate calculation for an average of detection values that have already been stored, for example (Step S34) and moves on to Step S36. In Step S34, an average value is calculated when a plurality of detection values from one sensor are stored in the RAM. The average value is stored in the RAM, and the original detection values are deleted from the RAM. In doing so, it is possible to prevent shortage of the storage capacity in the RAM. In such a case, the sub-control unit 150 may transmit the average value as the detection values of the sensor to the control unit 110.

The operations in Steps S32 to S35 make it possible to prevent missing of the detection values of the image display unit 20 even in a case in which data of detection values cannot be received since the processing of the control unit 110 is occupied by processing of receiving data of content from the external device to the control unit 110, for example.

In Step S36, the sub-control unit 150 determines whether or not a completion condition has been established (Step S36). If the completion condition has not been established (Step S36: NO), the processing returns to Step S28, and detection values are obtained. If the completion condition has been established (Step S36: YES), the processing is completed. The completion condition is, for example, a fact that a command for instructing completion of the processing has been received from the control unit 110 or a fact that the processing has been completed a designated number of times when the detection value request command from the control unit 110 designates the number of times the detection values are obtained.

As described above, the sub-control unit 150 controls the sensors including the first sensor 161, the second sensor 162, the GPS 163, and the illuminance sensor 164, obtains the detection values, and transmits the detection values to the control unit 110. Therefore, it is possible to significantly reduce the processing burden of the control unit 110 and occupancy time of processing performed by the control unit 110 as compared with a case in which the control unit 110 controls the respective sensors. If the respective sensors are connected to the control unit 110, it is difficult to transmit detection values of the sensors with different sampling cycles with the same signal line. Therefore, the number of signal lines provided in the connection unit 40 increases as the number of sensors increases. For this reason, the thickness of the harness that serves as the connection unit 40 increases, and there is a concern that unfavorable situations such as deterioration of routing and a limitation of the number of sensors occur. By causing the sub-control unit 150 to obtain the detection values of the respective sensors, adjusting transmission timing via the control data bus 41A, and transmitting the detection values of the plurality of sensors as in the embodiment, it is possible to prevent all such situations and to realize efficient processing. For example, the sub-control unit 150 may preferentially perform an operation of transmitting a detection value of a sensor with a short sampling cycle at a preset timing, and a detection value of another sensor with a long sampling cycle may be transmitted during spare time of the operation.

The control unit 110 controls the head-mounted display apparatus 100 by using the detection values received from the sub-control unit 150 by the operation illustrated in FIGS. 4A and 4B. For example, the control unit 110 can perform operation of obtaining latency due to a difference in access time of the sensors based on the time stamp information that is added to the detection values by the sub-control unit 150, calculating interpolation information, and correcting the latency.

Although the operation of obtaining data from the sensors every time the sub-control unit 150 transmits data is illustrated in FIGS. 4A and 4B, the embodiment of the invention is not limited thereto. The sub-control unit 150 may obtain sensor data at the sampling timing of the sensors in parallel and may store the obtained data without transmitting the data to the control unit 110. In such a case, the sub-control unit 150 transmits the stored data at timing, which is determined in advance by the control of the control unit 110, to the control unit 110. In addition, the sub-control unit 150 may collectively transmit latest data in the stored data to the control unit 110. Furthermore, the data that is transmitted by the sub-control unit 150 may include data that has not been updated since previous acquisition from the sensors. That is, the sub-control unit 150 may also transmit data to the control unit 110 every time for a sensor whose sampling cycle, at which the sub-control unit 150 obtains data, is longer than an interval at which the sub-control unit 150 transmits data to the control unit 110. In such a case, the sub-control unit 150 may collectively execute the processing of providing a time stamp to the data from the sensor when the sub-control unit 150 transmits the data to the first control unit. In such a case, the time stamp is collectively provided to a plurality of pieces of data that are temporarily stored in the sub-control unit 150. Alternatively, the sub-control unit 150 may provide the time stamp to the detection values of the respective sensors every time the sub-control unit 150 obtains data of the detection values from the sensors.

In addition, the sub-control unit 150 may perform processing of providing a time stamp to captured image data when the sub-control unit 150 transmits the captured image data of the camera 61 to the control unit 110.

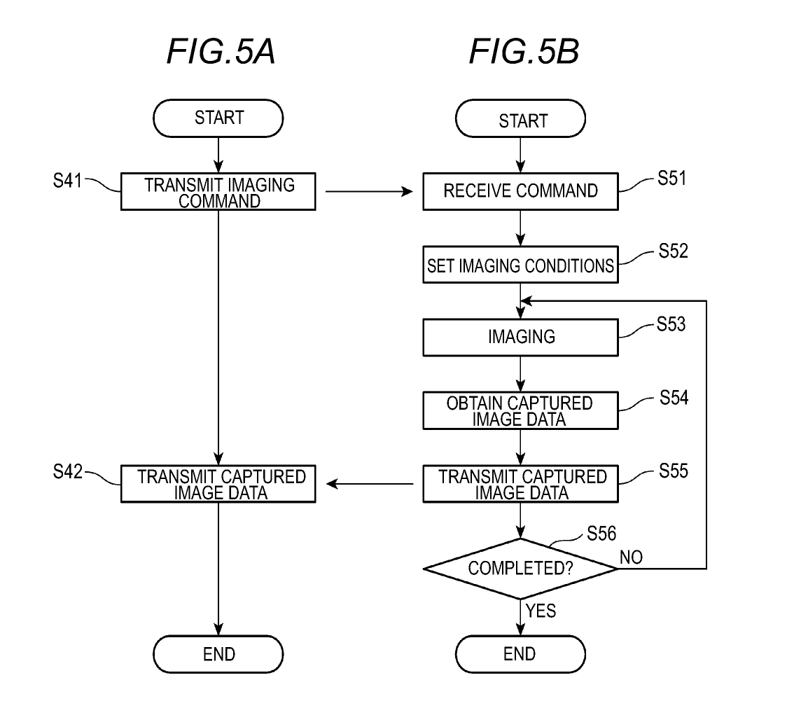

FIGS. 5A and 5B are flowcharts illustrating operations of the head-mounted display apparatus 100, where FIG. 5A illustrates operations of the control device 10, and FIG. 5B illustrates operations of the image display unit 20. FIGS. 5A and 5B illustrate operations when the sub-control unit 150 is controlled by the control unit 110 to cause the camera 61 to capture an image.

In such a case, the control unit 110 transmits an imaging command (Step S41) for instructing the sub-control unit 150 to capture an image (Step S41). The imaging command may include data for designating which of a moving image and a stationary image is to be captured and data for designating imaging conditions such as imaging resolution, an amount of captured image data, imaging frequency (a frame rate or an imaging interval), and the like. The sub-control unit 150 receives the imaging command (Step S51) and sets imaging conditions based on data included in the received imaging command or data of default imaging conditions (Step S52).

The sub-control unit 150 controls the camera 61 to capture an image (Step S53) and obtains captured image data (Step S54). The sub-control unit 150 transmits the obtained captured image data to the control unit 110 via the image data bus 41B (Step S55), and the control unit 110 receives the captured image data (Step S42).

The sub-control unit 150 determines whether or not a completion condition has been established (Step S56). If the completion condition has not been established (Step S56: NO), then the processing returns to Step S53, and an image is captured. If the completion condition has been established (Step S56: YES), the processing is completed. The completion condition is, for example, a fact that a command for instructing completion of the imaging has been received from the control unit 110 or a fact that imaging has been completed a number of times or for a period of time that is designated by the imaging command from the control unit 110.

Since the sub-control unit 150 controls the camera 61 to capture an image, obtains captured image data, and transmits the captured image data to the control unit 110 as described above, it is possible to significantly reduce the processing burden of the control unit 110 as compared with a case in which the control unit 110 controls the camera 61. Although exchange of commands via the control data bus 41A and exchange of captured image data via the image data bus 41B are performed between the control unit 110 and the sub-control unit 150, an amount of data does not significantly increase as compared with the case in which the control unit 110 controls the camera 61. Therefore, efficiency does not deteriorate due to execution of the processing by the sub-control unit 150.

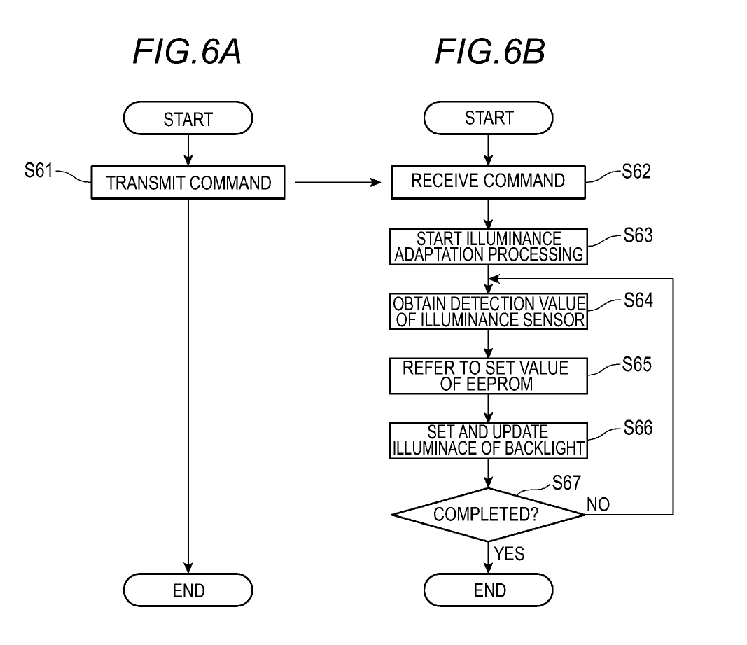

FIGS. 6A and 6B are flowcharts illustrating operations of the head-mounted display apparatus 100, where FIG. 6A illustrates operations of the control device 10, and FIG. 6B illustrates operations of the image display unit 20.

FIGS. 6A and 6B illustrate an example in which the sub-control unit 150 executes processing based on detection values of the sensors in response to a command that is transmitted by the control unit 110. In such a case, the control unit 110 creates and transmits a command for instructing execution of processing (Step S61), and the sub-control unit 150 receives the command (Step S62). In the example illustrated in FIGS. 6A and 6B, the control unit 110 instructs execution of illuminance adaption processing of adjusting brightness of the right backlight 221 and the left backlight 222 (FIG. 2) based on detection values of the illuminance sensor 164.

The sub-control unit 150 starts the illuminance adaption processing in response to the received command (Step S63) and obtains a detection value of the illuminance sensor 164 (Step S64). The sub-control unit 150 refers to a setting value that is stored in the EEPROM 165 (Step S65). The EEPROM 165 stores data of a setting value for correcting individual variations of the right backlight 221 and the left backlight 222, for example. The sub-control unit 150 executes computation processing by using the detection value, which is obtained in Step S64, based on the referred setting value, and sets luminance of the right backlight 221 and the left backlight 222, or updates the setting value (Step S66).

The sub-control unit 150 determines whether or not a completion condition has been established (Step S67). If the completion condition has not been established (Step S67: NO), the processing returns to Step S64, and a detection value is obtained. Here, the sub-control unit 150 may set an execution interval of the processing in Steps S64 to S66 and a sampling cycle of the illuminance sensor 164 in Step S63, for example.

If the completion condition has been established (Step S67: YES), the processing is completed. The completion condition is, for example, a fact that a command for instructing completion of the illuminance adaption processing has been received from the control unit 110 or a fact that the operation has been completed a predetermined number of times or for a period of time that is designated by the command from the control unit 110.

In the example illustrated in FIGS. 6A and 6B, the sub-control unit 150 can process the detection value of the illuminance sensor 164, control the backlight drive units 169 and 170, and adjust luminance of the right backlight 221 and the left backlight 222 in accordance with peripheral brightness. It is a matter of course that the control unit 110 can execute the illuminance adaption processing. For example, it is only necessary for the sub-control unit 150 to obtain the detection value of the illuminance sensor 164 and transmit the detection value to the control unit 110, and for the control unit 110 to transmit control data for controlling the backlight drive units 169 and 170 to the control unit 110. The operations illustrated in FIGS. 6A and 6B make it possible to reduce the processing burden of the control unit 110 as compared with a case in which the control unit 110 executes the illuminance adaption processing. First, it is not necessary to adjust timing at which the detection value of the illuminance sensor 164 with a relatively slow sampling cycle and detection values of the first sensor 161, the second sensor 162, and the like with relatively fast sampling cycles are transmitted. Therefore, it is possible to reduce the burden on the sub-control unit 150 in relation to the adjustment of the transmission timing. In addition, if a situation such as a transmission failure occurs as described above during the transmission of the detection value of the illuminance sensor 164, a delay occurs until the luminance is adjusted after the detection value of the illuminance sensor 164 is obtained. Since no delay occurs in relation to the transmission of the detection value if the sub-control unit 150 executes the illuminance adaption processing, it is possible to quickly and appropriately adjust the luminance of the right backlight 221 and the left backlight 222.

The description was given of the processing based on the detection value of the illuminance sensor 164 as an example of processing in which the sub-control unit 150 changes a display state of the image display unit 20 in accordance with an environment of the image display unit 20 based on a detection value of a sensor, with reference to FIGS. 6A and 6B. The processing executed by the sub-control unit 150 is not limited to the example. For example, the image display unit 20 may be provided with a temperature sensor, the temperature sensor may be connected to the sub-control unit 150, and the sub-control unit 150 may perform control based on a temperature. In such a case, the sub-control unit 150 may control the LCD drive units 167 and 168 and the BL drive units 169 and 170 so as to suppress deterioration of the image display unit 20, in accordance with an environment temperature of the image display unit 20 that is detected by the temperature sensor. In doing so, it is possible to extend life duration of the respective components including the right backlight 221, the left backlight 222, the right LCD 241, and the left LCD 242. Such a configuration can be realized by providing a moisture sensor in addition to or instead of the temperature sensor. In addition, the sub-control unit 150 may perform processing of detecting a background color of an outside view that is visually recognized by the user based on an image captured by the camera 61 and adjusting a color tone of an image to be displayed by the image display unit 20 in accordance with the background color. Alternatively, the sub-control unit 150 may be connected to a microphone (not shown) and perform processing corresponding to environment sound that is detected by the microphone. The processing may include processing of adjusting sound to be output in a case of a configuration in which the image display unit 20 outputs sound from a speaker or a headphone, as well as control of display performed by the image display unit 20.

The processing executed by the sub-control unit 150 in response to the command from the control unit 110 is not limited to the examples illustrated in FIGS. 5A to 6B. For example, the sub-control unit 150 can perform an operation of changing a type of data when the control unit 110 transmits a command for instructing switching of the type of the data. Specifically, when the control unit 110 requires data of a distance to a target that is located in front of the user who wears the image display unit 20 or a target that is within an imaging range of the camera 61, the control unit 110 instructs the sub-control unit 150 to transmit the data of the distance. The sub-control unit 150 analyzes captured image data of the camera 61, detects an image of an object in the captured image data, calculates data of the distance based on a size and the like in the captured image, and transmits the calculated data of the distance. In such a case, the sub-control unit 150 does not transmit the captured image data of the camera 61 to the control unit 110. That is, the type of the data to be transmitted is switched from the captured image data to the data of the distance.

It is a matter of course that the opposite switching can also be performed. When the control unit 110 transmits a command for requesting the captured image data and not requesting the data of the distance, the captured image data may be transmitted to the control unit 110 without causing the sub-control unit 150 to obtain the captured image data.

As described above, the head-mounted display apparatus 100 according to the first embodiment to which the invention is applied includes the image display unit 20 and the plurality of sensors including the first sensor 161, the second sensor 162, the GPS 163, and the illuminance sensor 164. In addition, the control unit 110 that controls the head-mounted display apparatus 100 and the sub-control unit 150 that is connected to the plurality of sensors and transmits data including detection values of the plurality of sensors to the control unit 110 are provided. Therefore, it is not necessary to connect the large number of sensors to the control unit 110 by using the sub-control unit 150, and the processing burden of the control unit 110 can be reduced by reducing the number of sensors that are directly controlled by the control unit 110. For example, the sub-control unit 150 that is connected to the plurality of sensors can execute processing in accordance with differences in specifications and properties of the respective sensors. In addition, it is not necessary to connect the respective sensors to the control unit 110, and detection values of the sensors can be collectively transmitted from the sub-control unit 150 to the control unit 110, for example. Therefore, it is possible to reduce the processing burden of the control unit 110, to reduce power consumption of the control unit 110, and to increase a processing speed of the control unit 110. Since it is not necessary to connect the large number of sensors to the control unit 110, it is possible to avoid complication of a circuit configuration of the control device 10.

According to the head-mounted display apparatus 100, the sub-control unit 150 collectively controls the plurality of sensors based on control by the control unit 110. Therefore, it is possible to perform detailed control on the large number of sensors without increasing the burden of the control unit 110.

In addition, since the sub-control unit 150 obtains the detection values of the plurality of sensors at a plurality of different sampling cycles, it is possible to reduce the processing burden of the control unit 110 in the processing of obtaining the detection values of the sensors.

In addition, the sub-control unit 150 obtains detection values of any of the plurality of sensors including the first sensor 161, the second sensor 162, the GPS 163, and the illuminance sensor 164 at a first sampling cycle and a second sampling cycle that is longer than the first sampling cycle. The sub-control unit 150 transmits data including the detection value of the sensor that is obtained at the first sampling cycle and the detection value of the sensor that is obtained at the second sampling cycle to the control unit 110. As described above, the control unit 110 can obtain detection values of a plurality of sensors with different sampling cycles, and the processing burden of the control unit 110 in the processing of obtaining the detection values can be reduced.

Since the sub-control unit 150 can execute processing that is set in advance based on the detection values of the sensors when the sub-control unit 150 receives a command from the control unit 110, the processing burden of the control unit 110 can be further reduced.

For example, the sub-control unit 150 executes, as predetermined processing, processing of changing a display state of the image display unit 20 in accordance with an environment of the image display unit 20 based on the detection values of the sensors. More specifically, the sub-control unit 150 can perform the processing of adjusting brightness (luminance) of the right backlight 221 and the left backlight 222 based on the detection value of the illuminance sensor 164 as illustrated in FIGS. 6A and 6B, and the burden on the control unit 110 can be reduced. In this example, the sub-control unit 150 is connected to the EEPROM 165 that stores setting data and can execute the predetermined processing by using the setting data that is stored in the EEPROM 165. Here, another configuration is also applicable in which the sub-control unit 150 includes a built-in ROM or a built-in RAM, and in such a case, the ROM or the RAM may store the setting data. Alternatively, another configuration is also applicable in which a ROM or the like is integrally provided with the sub-control unit 150, and in such a case, the ROM may store the setting data.

Since the sub-control unit 150 holds the detection values obtained from the sensors in the built-in RAM, for example, until the sub-control unit 150 transmits the detection values to the control unit 110, the control unit 110 can execute processing without being restricted by the timing at which the sub-control unit 150 obtains the detection values of the sensors.

In addition, the sub-control unit 150 can execute processing for detection values of other sensors based on the detection values of any of the sensors, and transmit the detection values after the processing to the control unit 110. For example, the sub-control unit 150 can perform processing of correcting, based on the detection values of the sensors, detection values of other sensors or processing such as sensor fusion.

The head-mounted display apparatus 100 includes a main body (first main body) of the control device 10 that includes the control unit 110 and a main body (second main body) of the image display unit 20 that includes the sub-control unit 150. The sub-control unit 150 is connected to the plurality of sensors that are provided in the main body of the image display unit 20. In addition, a sensor is provided in the main body of the control device 10, and the sensor that is provided in the main body of the control device 10 is connected to the control unit 110. In such a configuration, the control unit 110 may calculate characteristic values based on detection values and positions of the sensors in the main body of the image display unit 20 and a detection value and a position of the sensor in the main body of the control device 10.

For example, characteristic values that indicate movement of the head-mounted display apparatus 100 may be obtained based on relative positions of a sensor IC in the control device 10 and the first sensor 161 and the second sensor 162 in the image display unit 20 and detection values such as acceleration rates or angular velocities that are detected by the respective sensors. That is, the characteristic values may be values that indicate moving speeds or moving directions of the entire head-mounted display apparatus 100. In addition, the control unit 110 may obtain characteristic values that include data indicating bearings by using detection values of the geomagnetic sensor. Furthermore, the control unit 110 may detect variations in relative positions of the control device 10 and the image display unit 20 and obtain characteristic values in relation to speeds or directions of displacement. Moreover, it is a matter of course that a configuration is also applicable in which a sub-control unit 150 is provided in the main body of the control device 10 and the control unit 110 is provided in the main body of the image display unit 20. Furthermore, a configuration is also applicable in which an optical system as a display unit, an LCD, and the like are provided in the main body of the control device 10. As described above, the control unit 110 can obtain characteristic values by using the detection value of the sensor in the main body of the control device 10 and the detection values of the sensors in the main body of the image display unit 20, and the burden on the control unit 110 can be reduced in relation to the calculation of the characteristic values.

Although the configuration in which the control unit 110 is provided in the main body of the control device 10 with a substantially box shape is described in the aforementioned embodiment, the control unit 110 may be provided in the main body that includes the image display unit 20, and the sub-control unit 150 may be provided in the main body of the control device 10 that is separate from the image display unit 20. In such a case, the control unit 110 is connected to the sensors in the main body of the image display unit 20, and the sensor in the main body of the control device 10 is connected to the sub-control unit 150. In other words, a configuration is applicable in which the image display unit 20 that the user wears on their head has a control function and a small-sized device that is separately formed from the image display unit 20 is provided with the sub-control unit 150. The configuration also has an advantage that a situation in which the thickness of the harness that forms the data bus increases can be avoided by reducing the burden on the control unit that controls the entire head-mounted display apparatus.

Furthermore, the control device 10 and the image display unit 20 may be integrally formed. That is, the main body of the control device 10 and the main body of the image display unit 20 are formed as a single main body. In such a case, the invention may be employed to a configuration in which the control unit 110 and the sub-control unit 150 are mounted on the same main body. For example, it is possible to consider a configuration in which the control unit 110 and the sub-control unit 150 that are mounted on the same main body are connected by a control data bus, an image data bus, and a display data bus and the control unit 110 and the sub-control unit 150 are connected to different sensors.

### Second Embodiment

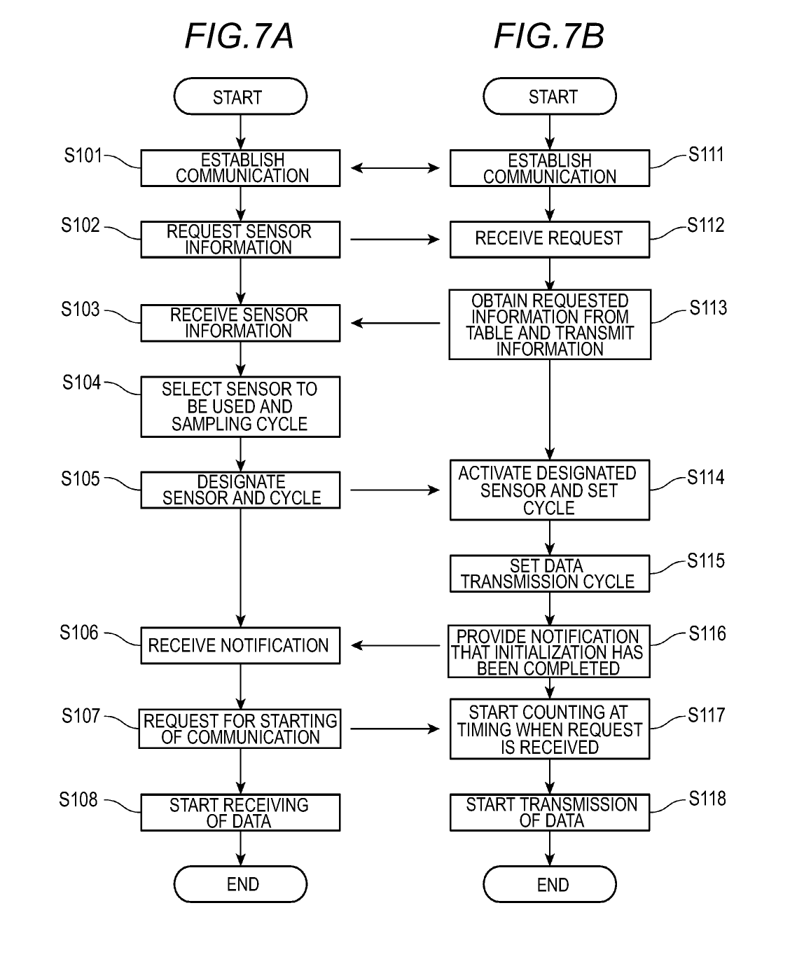

FIGS. 7A and 7B are flowcharts illustrating operations of a head-mounted display apparatus 100 according to a second embodiment to which the invention is applied, where FIG. 7A illustrates operations of a control device 10, and FIG. 7B illustrates operations of an image display unit 20.

A configuration of the head-mounted display apparatus 100 according to the second embodiment is the same as that of the first embodiment. Since the control device 10 and the image display unit 20 have the configurations described above with reference to FIGS. 1 to 3, the same reference numerals will be given to configurations and functional blocks of the respective devices, and depictions and explanations thereof will be omitted.

FIGS. 7A and 7B are flowcharts that are executed when the head-mounted display apparatus 100 is started, for example, for performing setting in relation to a detection operation of a sub-control unit 150 by exchanging control data between the control unit 110 and the sub-control unit 150.

The control unit 110 and the sub-control unit 150 exchange various kinds of control data in relation to start of communication and establish communication via a connection unit 40 (Steps S101, S111).

Then, the control unit 110 requests sensor information in relation to sensors, from which the sub-control unit 150 can obtain detection results, to the sub-control unit 150 (Step S102). The sub-control unit 150 receives the request of the sensor information (Step S112), then reads the requested sensor information from an EEPROM 165, and transmits the sensor information to the control unit 110 (Step S113).

The image display unit 20 stores the sensor information of various sensors that are connected to the sub-control unit 150. Although the sensor information may be stored in a built-in ROM in a microcomputer or an SoC that serves as the sub-control unit 150, for example, the sensor information may be stored in the EEPROM 165 in this embodiment.

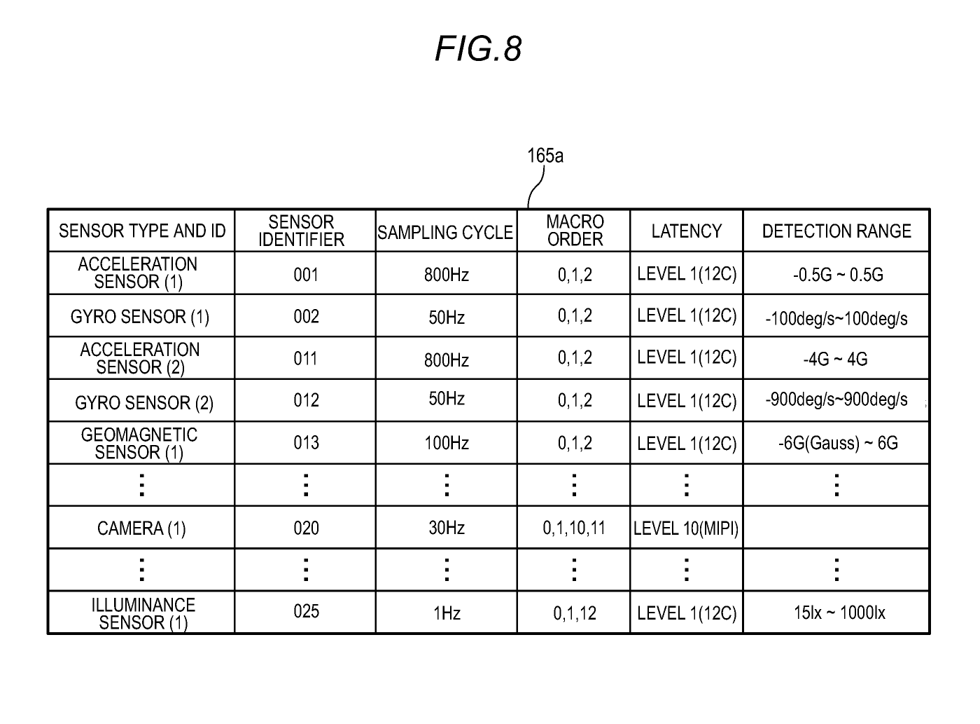

FIG. 8 is a diagram schematically illustrating a configuration example of sensor information 165a that is stored in the EEPROM 165. The sensor information 165a in this embodiment is formed in a table format as illustrated in FIG. 8.

The sensor information 165a includes information for specifying sensors from which the sub-control unit 150 can obtain detection values and sensor identifiers that are associated with the respective sensors. The sensor identifiers are information that is used by the control unit 110 and the sub-control unit 150 to specify the respective sensors. For example, if the sensor identifiers are included in detection results that are transmitted from the sub-control unit 150 to the control unit 110 as will be described later, the control unit 110 can specify which of sensors each detection result belongs to.

As information for specifying sensors, the sensor information 165a illustrated in FIG. 8 includes types of sensors and IDs that are provided to the sensors in advance. For example, an acceleration sensor (1) indicates an acceleration sensor to which an ID “1” is provided from among acceleration sensors that are provided in the image display unit 20. The image display unit 20 can include a plurality of the same type of sensors. If a first sensor 161 includes a three-axis acceleration sensor and a three-axis gyro sensor, and a second sensor 162 includes a three-axis acceleration sensor, a three-axis gyro sensor, and a three-axis geomagnetic sensor, the image display unit 20 includes the two acceleration sensors. In such a case, it is possible to distinguish the respective acceleration sensors by providing IDs “1” and “2”, for example, to the respective acceleration sensors. The sensor information 165a includes information for specifying the respective sensors, preferably all the sensors, which are directly or indirectly connected to the sub-control unit 150, and from which the sub-control unit 150 can obtain detection results.

The sensor identifiers preferably have a simple configuration in consideration of convenience when the sensor identifiers are included in data to be transmitted from the sub-control unit 150 to the control unit 110 as information for identifying the respective sensors. For example, the sensor identifiers are represented by symbols such as numbers or characters as illustrated in FIG. 8. The same identifier is not provided to different sensors. If the sensors that are provided in the image display unit 20 are formed of a composite element including a plurality of sensors, it is preferable to provide sensor identifiers to the respective sensors.

The sensor information 165a includes sampling cycles (sampling frequencies) of detection values in association with the sensor identifiers. Sampling cycles that can be handled by the sensors are determined depending on specifications or properties of the sensors. Information in relation to the sampling cycles included in the sensor information 165a is determined based on rating set forth by manufactures of the sensors and operation conditions of the head-mounted display apparatus 100. If there are a plurality of sampling cycles that can be handled by the sensors, or if a range of sampling cycles that can be handled by the sensors is set, the sensor information 165a includes information that indicates an upper limit of the sampling cycles that can be handled.

The sensor information 165a includes a “macro-order” as information indicating processing that can be executed by the sub-control unit 150 in relation to acquisition of detection values of the sensors. The processing that can be executed by the sub-control unit 150 includes, for example, setting of sampling cycles and setting of operation conditions (detection sensitivity, detection ranges, and the like) of the sensors. The “macro-order” includes a code indicating processing that the sub-control unit 150 performs on the sensors in response to transmission of a command from the control unit 110. In response to transmission of a command designating a code from the control unit 110, the sub-control unit 150 executes processing corresponding to the code. Codes and content of processing are set in advance in the sub-control unit 150 and the control unit 110. For example, the sub-control unit 150 can execute processing of a code 0, processing of a code 1, and processing of a code 2 on the acceleration sensor (1).

The sensor information 165a includes information indicating latency that occurs when detection values of the sensors are obtained. The information of the latency is set based on actually measured values or a specification of an interface that connects the sensors and the sub-control unit 150. In the example illustrated in FIG. 8, the latency is represented in levels that are classified in advance.

In addition, the sensor information 165a may include other information in relation to the specifications and the properties of the sensors. In the example illustrated in FIG. 8, information indicating detection ranges of the respective sensors is included. The invention is not limited to the example, and the sensor information 165a may include information indicating definition of detection values of the sensors, resolution of the sensors, detection precision, or temperature properties of the detection values.

The control unit 110 may request information about all the sensors from which the sub-control unit 150 can obtain detection results or may request information about necessary types of sensors in Step S102. The sub-control unit 150 refers to the sensor information 165a, obtains the requested information, and transmits the information to the control unit 110 in Step S113.

The control unit 110 receives the information that is transmitted from the sub-control unit 150 (Step S103), selects and determines sensors and sampling cycles to be used based on the received information (Step S104). In Step S104, sensors to be used are selected in response to a request from an application program that is executed by the control unit 110, for example. The sampling cycles are similarly selected. Alternatively, conditions such as definition of sensors may be determined in Step S104 in response to the request from the application program that is executed by the control unit 110 or in accordance with a specification. In Step S104, a sampling cycle and other conditions are selected for each of the sensors.

The control unit 110 transmits information that designates the sensors, the sampling cycles, and other conditions that are selected in Step S104 to the sub-control unit 150 (Step S105). The sub-control unit 150 receives the information that is transmitted by the control unit 110 and performs processing of activating the designated sensors and processing of setting the sampling cycles (Step S114). The activation of the sensors includes turning-on of the sensors, initialization, and recovery from a sleep state. The sampling cycles (sampling frequencies) are set as interruption timing of interruption processing that is performed by the sensors on the sub-control unit 150, for example. After the activation of the sensors and the setting of the sampling cycles are performed in Step S114, the sub-control unit 150 may start detection by the activated sensors and start acquisition of the detection values.

When the sampling cycles are set in Step S114, timing at which interruption processing is performed by the sensors on the sub-control unit 150 is set, for example. The sensors that are connected to the sub-control unit 150 are not limited to the sensors that perform the interruption processing on the sub-control unit 150. For example, a sensor that outputs an analog voltage to the sub-control unit 150 may be used. Such a type of sensor may directly output the analog voltage to the sub-control unit 150 or may be connected to the sub-control unit 150 via a gate array or an A/D converter that converts an analog output value to digital data. Such a type of sensor constantly outputs an output value to the sub-control unit 150. In relation to such a type of sensor, the sub-control unit 150 may set a sampling cycle as timing at which the sub-control unit 150 detects or obtains a detection value of the senor (the analog voltage value or the output value that is converted into the digital data) in Step S114.

As a sensor that is connected to the sub-control unit 150, a sensor that outputs a detection value to the sub-control unit 150 by using interruption processing (interruption control), in which the sub-control unit 150 obtains an output value from the sensor, as a trigger may be used. In relation to such a type of sensor, the sub-control unit 150 may set a sampling cycle as timing at which the sub-control unit 150 provides the trigger, which is detection or acquisition of the detection value, to the sensor in Step S114.

The sub-control unit 150 sets a cycle at which data including detection values of the sensors is transmitted to the control unit 110 (Step S115). In Step S115, for example, the sub-control unit 150 sets the cycle in accordance with the fastest sampling cycle (shortest cycle) from among the sampling cycles of the sensors that are requested by the information that is transmitted by the control unit 110 in Step S105.

In Step S105, the control unit 110 may designate a cycle at which the data is transmitted from the sub-control unit 150 to the control unit 110. In such a case, the sub-control unit 150 respectively sets target sensors from which detection values are obtained and sampling cycles at which the sub-control unit 150 obtains the detection values from the respective target sensors, and a cycle (update interval) at which the sub-control unit 150 transmits the data to the control unit 110 in response to designation by the control unit 110.

The sub-control unit 150 transmits notification that initialization has been completed to the control unit 110 (Step S116) and waits for a communication start request.

The control unit 110 receives the notification that is transmitted from the sub-control unit 150 (Step S106) and requests the sub-control unit 150 to start communication (Step S107).

The sub-control unit 150 starts counting of a timer by using the reception of the communication start request as interruption timing (Step S117) and starts data transmission to the control unit 110 in accordance with the transmission cycle that is set in Step S115 (Step S118).

In addition, the control unit 110 starts reception of the data that is transmitted by the sub-control unit 150 (Step S108).

Here, the control unit 110 can start counting of the timer when the communication start request is transmitted in Step S107. In such a case, since the control unit 110 and the sub-control unit 150 start the counting of the timers in a synchronized manner, the control device 10 and the image display unit 20 are synchronized. When there is latency between the transmission and the reception of the communication start request, the control unit 110 may start the counting at timing obtained by taking the latency into consideration.

If exchange of the data is started in Steps S108 and S118, the control unit 110 and the sub-control unit 150 execute the operations that are described above in Step S13 and Steps S27 to S36 in FIGS. 4A and 4B, for example.

Here, the control unit 110 may store the detection values of the sensors that are included in the data received from the sub-control unit 150 in the memory 121 or the flash memory 122 in association with a time code. In such a case, the data of the detection values stored in the memory 121 or the flash memory 122 may be cumulatively stored or may be rewritten with the latest detection values.

In Step S105, the control unit 110 may set a plurality of cycles as cycles at which the sub-control unit 150 transmits the data to the control unit 110. For example, three-stage cycles of Fast (150 Hz), Normal (100 Hz), and Slow (50 Hz) may be designated. In such a case, the sub-control unit 150 sets the three cycles, namely Fast (150 Hz), Normal (100 Hz), and Slow (50 Hz) and transmits data to the control unit 110 in accordance with the respective cycles. In a specific example, the sub-control unit 150 transmits, at the cycle of Fast (150 Hz), data including a detection value of an acceleration sensor that corresponds to a sensor with a short sampling cycle (fast). In addition, the sub-control unit 150 transmits, at the cycle of Normal (100 Hz), data including a detection value of a geomagnetic sensor with a longer sampling cycle (slower) than that of the acceleration sensor, and transmits, at the cycle of Slow (50 Hz), data including captured image data of the camera. As described above, a plurality of cycles at which data is transmitted may be set for the sub-control unit 150, and types of detection values included in data that is transmitted at the respective cycles, namely types of sensors may be designated for the respective cycles.

A configuration is applicable in which the control unit 110 sets a plurality of cycles of data transmission in Step S105 and cycles to be used from among the set cycles can be switched as necessary by control data. In such a case, the sub-control unit 150 sets the aforementioned three cycles, namely Fast (150 Hz), Normal (100 Hz), and Slow (50 Hz), for example, in accordance with the information received in Step S114. That is, the sub-control unit 150 is set so as to be able to switch the plurality of cycles in the initialization operation in Step S115. The sub-control unit 150 selects a cycle to be used from among the set three cycles based on information that is transmitted by the control unit 110 and starts data transmission at the selected cycle. In such a case, the sub-control unit 150 switches the data transmission cycle by the control unit 110 transmitting control data for instructing switching of the transmission cycle after the data transmission from the sub-control unit 150 to the control unit 110 is started in Steps S108 and S 118. In such a case, the sub-control unit 150 selects another cycle from among the cycles that are set in Step S115, by using the reception of the control data from the control unit 110 as interruption processing.

Here, the sub-control unit 150 can select a transmission format, which is designated by the control unit 110, for the sensor that is selected by the control unit 110 from among the sensors connected to the sub-control unit 150. For example, the sub-control unit 150 can select and use a format that is requested (designated) by the control unit 110 as a transmission format in which the detection value of the acceleration sensor is transmitted to the control unit 110 from among a 50 Hz transmission format, a 100 Hz transmission format, and a 150 Hz transmission format. The “transmission format” in this case may indicate a data transmission cycle or also include a frame configuration or the like of the data. Different transmission formats (or transmission cycles) can be employed for the same type of sensors.

The sub-control unit 150 can obtain a detection value of a sensor at a higher speed (shorter cycle) than the transmission cycle that is requested by the control unit 110. For example, the sub-control unit can obtain a detection value of the acceleration sensor at 150 Hz and transmit data including the detection value of the acceleration sensor to the control unit 110 at 50 Hz. In such a case, the sub-control unit 150 may transmit, to the control unit 110, data including three detection values that are obtained from the acceleration sensor. Alternatively, the sub-control unit 150 may transmit, to the control unit 110, data including the latest one detection value of the acceleration sensor that is obtained in accordance with the cycle of the data transmission to the control unit 110.

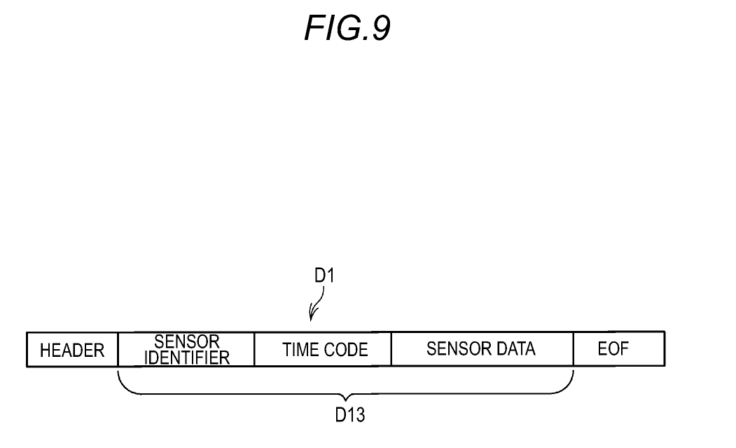

FIG. 9 is a diagram schematically showing an example of a transmission format of data to be transmitted from the sub-control unit 150 to the control unit 110.

The data that is transmitted from the sub-control unit 150 to the control unit 110 is formed of a frame with a predetermined length and includes a header, an EOF, and a payload, and the payload stores data including detection values of the sensors.

The transmission format of data D1 illustrated in FIG. 9 includes, in a payload D13, a sensor identifier, sensor data as a detection value of the sensor that is indicated by the sensor identifier, and a time code at which the sensor data is obtained. The time code is a timer count value at the time when the sub-control unit 150 obtains the detection value of the sensor. If the sub-control unit 150 transmits data to the control unit 110 in the transmission format illustrated in FIG. 9, the control unit 110 can obtain the detection result of the sensor that is obtained by the sub-control unit 150 and the timing at which the detection result is obtained. When there is a delay until the control unit 110 receives and processes the detection result of the sensor, for example, the control unit 110 can calculate the delay based on the received time code and the timer count value of the control unit 110 and perform processing while taking the delay into consideration.

In addition, the data D1 can be a format in which the sensor identifier and the sensor data are included in the payload D13 and the time code is not included.

The sub-control unit 150 can transmit a frame that includes detection results of a plurality of sensors. Since a combination of a sensor identifier, sensor data, and a time code corresponds to a detection result of one sensor in the payload D13, a plurality of such combinations can be stored in the payload D13.

When the control unit 110 designates a plurality of cycles as cycles at which data is transmitted in Step S105, and the sub-control unit 150 transmits the data at the plurality of cycles as described above, the sub-control unit 150 may transmit the data in different transmission formats depending on the cycles. For example, the sub-control unit 150 may transmit data in the transmission format illustrated in FIG. 9 when the data is transmitted at the cycle of Slow (50 Hz) and transmit data in a different data format when the data is transmitted at the cycle of Fast (150 Hz).

As described above, the sub-control unit 150 may be able to transmit data including the detection results of the sensors to the control unit 110 in any of a first transmission format corresponding to the first sampling cycle and a second transmission format corresponding to the second sampling cycle. In such a case, since the sub-control unit 150 transmits the data including the detection results of the sensors in the transmission formats corresponding to the sampling cycles, it is possible to obtain the detection results of the sensors and to transmit the data including the detection results at sampling cycles suitable for the sensors.

Alternatively, the sub-control unit 150 may select any of the first transmission format and the second transmission format based on a sampling cycle that is requested by the control unit 110 and transmit the data including the detection result of the sensors. In such a case, it is possible to obtain the detection results at the requested sampling cycles and to transmit the data including the detection results in the transmission formats suitable for the sampling cycles.

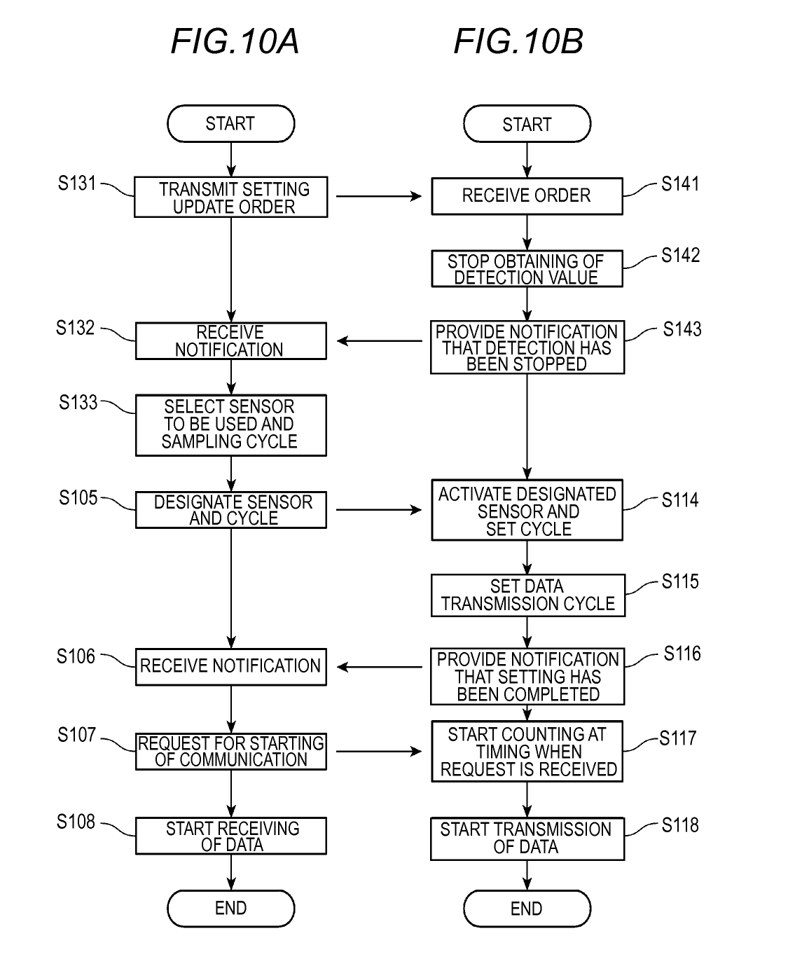

FIGS. 10A and 10B are flowcharts illustrating operations of the head-mounted display apparatus 100, where FIG. 10A illustrates operations of the control device 10, and FIG. 10B illustrates operations of the image display unit 20.

The operations illustrated in FIGS. 10A and 10B are operations for changing setting after the initial setting of the image display unit 20 has been completed by the operations in FIGS. 7A and 7B and the data transmission has been started.

If the control unit 110 transmits a setting update order to the sub-control unit 150 (Step S131), the sub-control unit 150 receives the order (Step S141) and stops acquisition of the detection values of the sensors (Step S142).

The sub-control unit 150 provides notification that the acquisition of the detection values has been stopped to the control unit 110 (Step S143), and the control unit 110 receives the notification from the sub-control unit 150 (Step S132). The control unit 110 selects and determines sensors and sampling cycles to be used in the same manner as in Step S104 (Step S133).

Thereafter, the control unit 110 executes the operations in Steps S105 to S108 described above with reference to the flowcharts in FIGS. 7A and 7B, and in response to the operations, the sub-control unit 150 executes the operations in Steps S114 to S118.

By the operations illustrated in FIGS. 10A and 10B, it is possible to change setting in relation to the data transmission cycles and sensors from which the detection values are obtained after the sub-control unit 150 starts the acquisition of the detection values of the sensors and the transmission of the data to the control unit 110.

When the sub-control unit 150 sets a plurality of cycles as the data transmission cycles as described above, processing of switching the set cycles may be performed by the operations illustrated in FIGS. 10A and 10B.

If no communication is established between the control unit 110 and the sub-control unit 150 when the operations of updating the setting illustrated in FIGS. 10A and 10B are performed, there is a possibility that the setting update has not been performed normally. As a countermeasure for such a case, the sub-control unit 150 may determine a communication state with the control unit 110 when the sub -control unit 150 receives the order in relation to the setting update from the control unit 110 in Step S141. For example, a configuration is applicable in which the sub-control unit 150 determines a communication state with the control unit 110 after the reception of the order in Step S141 and does not stop the acquisition of the detection values of the sensors until it is determined that the communication state is normal or satisfactory. In such a case, it is only necessary for the sub-control unit 150 to move on Step S142, stop acquisition of the detection values of the sensors, and then execute the processing in Step S143 and the following steps after it is determined that the communication state with the control unit 110 is normal or satisfactory.

As described above, the head-mounted display apparatus 100 according to the second embodiment to which the invention is applied performs the transmission synchronization processing for synchronizing the timing at which the sub-control unit 150 transmits the data to the control unit 110 and the setting of the data to be transmitted from the sub-control unit 150 to the control unit 110 as illustrated in FIGS. 7A and 7B. In doing so, the sub-control unit 150 and the control unit 110 can perform the counting while synchronizing the timing at which the detection values of the sensors are obtained. For this reason, it is possible for the control unit 110 to process the data including the detection values of the sensors by taking the timing, at which the detection values are obtained, into consideration and to thereby efficiently perform the data processing.

In addition, the image display unit 20 stores, as the sensor information 165a, for example, information related to the sensors that are connected to the sub-control unit 150 in the EEPROM 165 (sensor information storage unit) that is connected to the sub-control unit 150. The control unit 110 sets the data to be transmitted by the sub-control unit 150 based on the information that is stored in the sensor information storage unit. In doing so, the control unit 110 can set the data including the detection results of the sensors by using the information related to the sensors and perform setting in accordance with properties and specifications of the sensors, for example.

The sensor information 165a that is stored in the EEPROM 165, for example, can be information that includes sensor identifiers for identifying sensors and sampling cycles at which detection results of the sensors are obtained in association with the sensors. In such a case, the sub-control unit 150 can identify the sensors and obtain the detection results at the sampling cycles corresponding to the respective sensors based on the sensor information 165a. In addition, the control unit 110 can identify the respective sensors and perform setting in accordance with specifications and properties of the respective sensors.

The sensor information 165a may include a “macro-code”, for example, as information that indicates processing that is executed by the sub-control unit 150 in accordance with the sensors. In such a case, the control unit 110 can designate the processing that is executed by the sub-control unit 150 in accordance with the sensors based on the sensor information 165a.

As the operations illustrated in FIGS. 7A and 7B, the control unit 110 transmits the control signal to the sub-control unit 150, and the sub-control unit 150 initializes the sensors that are connected to the sub-control unit 150 when the control signal for instructing the initialization is received from the control unit 110. Therefore, the sub-control unit 150 can initialize the sensors at the timing designated by the control unit 110 by using the control signal as a trigger.

When the sub-control unit 150 receives the control signal for instructing the initialization from the control unit 110 and initializes the sensors, the sub-control unit 150 executes synchronization processing (Steps S107 and S117) with the control unit 110. The sub-control unit 150 can add time codes, as data of detection time, to the detection results of the sensors that are obtained thereafter and transmit the detection results to the control unit 110. For this reason, the control unit 110 and the sub-control unit 150 can initialize the sensors in the synchronized manner. In doing so, it is possible to perform processing on the data including the detection results of the sensors while taking the detection timing into consideration.

In the synchronization processing, the control unit 110 transmits a synchronization signal to the sub-control unit 150 at predetermined timing, and the sub-control unit 150 performs the synchronization based on the synchronization signal that is transmitted by the control unit 110.

According to the embodiment, it is possible to synchronize the control unit 110 and the sub-control unit 150 by exchanging the synchronization signal.

After the execution of the synchronization processing, each of the control unit 110 and the sub-control unit 150 executes counting of the timer, and the sub-control unit 150 transmits data that is obtained by adding time codes indicating acquisition time to the obtained detection results when the sub-control unit 150 obtains the detection results of the sensors. Therefore, the control unit 110 can receive the data including the detection results of the sensors and exchange the time at which the detection results are obtained. In addition, the sub-control unit 150 may embed the time codes indicating the acquisition time at which the detection results of the sensors are obtained in the data of the obtained detection results. Alternatively, the sub-control unit 150 may create data by adding the time codes to the detection results and transmit the created data. In any of these formats, the control unit 110 that receives the data can efficiently perform processing by using the detection values of the sensors.

### Third Embodiment

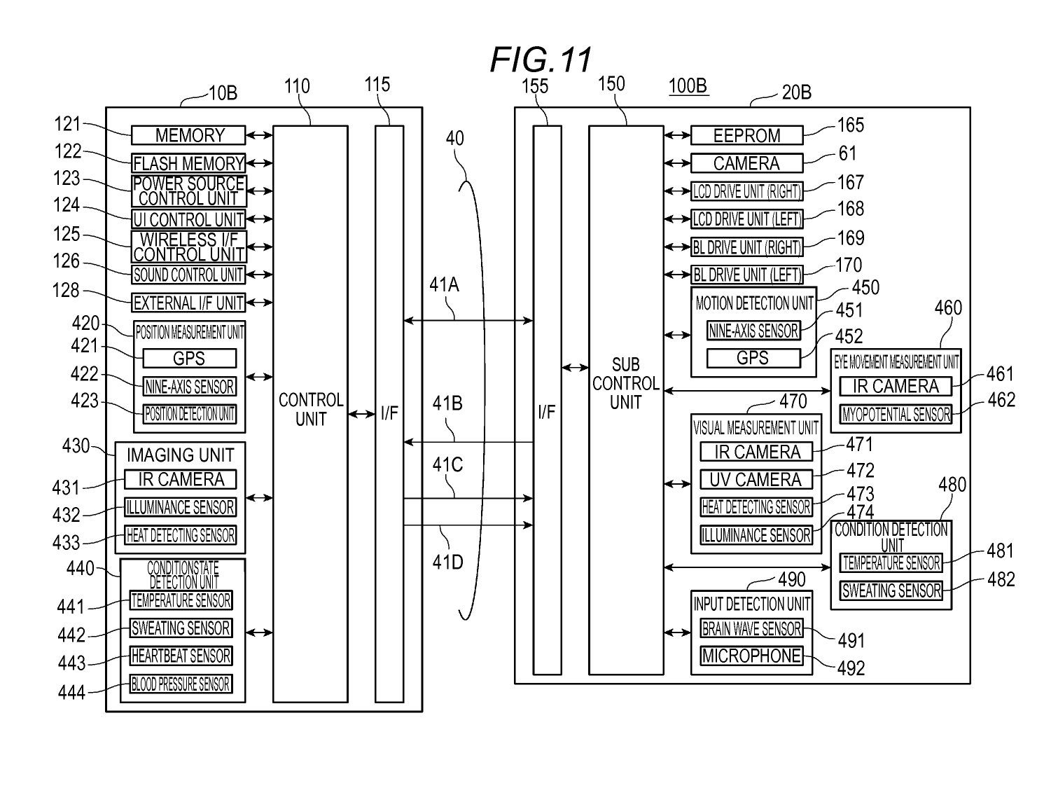

FIG. 11 is a functional block diagram of the respective components in a head-mounted display apparatus 100B according to a third embodiment to which the invention is applied. In a configuration of the head-mounted display apparatus 100B illustrated in FIG. 11, the same reference numerals will be given to the same components as those in the head-mounted display apparatus 100 (FIG. 3) described above in the first embodiment, and the descriptions thereof will be omitted.

The head-mounted display apparatus 100B has a configuration that represents specific examples of the various sensors in the control device 10 and the various sensors in the image display unit 20 in the head-mounted display apparatus 100 according to the first embodiment.

That is, a control device 10B includes a position detection unit 420, an imaging unit 430, and a condition detection unit 440 as a configuration that was described above as the sensor IC 127 in the control device 10. The position detection unit 420 includes a GPS 421, a nine-axis sensor 422, and a position detection unit 423. The imaging unit 430 includes an IR camera 431, an illuminance sensor 432, and a heat detecting sensor 433. The condition detection unit 440 includes a temperature sensor 441, a sweating sensor 442, a heartbeat sensor 443, and a blood pressure sensor 444.

The GPS 421 (first GPS receiving unit) receives a position detecting signal that is transmitted by a GPS satellite or a pseudo-GPS transmitter (not shown) that is installed indoors and calculates a present position of the image display unit 20. The position detection unit 420 outputs information of the present position, which is calculated by the IR camera 431, to the control unit 110 based on a control signal that is input from the control unit 110 or at a cycle that is set in advance.

The nine-axis sensor 422 is a motion sensor including a three-axis acceleration sensor, a three-axis gyro sensor, and a three-axis geomagnetic sensor. The position detection unit 420 outputs detection values of the three-axis acceleration sensor, the three-axis gyro sensor, and the three-axis geomagnetic sensor in the nine-axis sensor 422 to the control unit 110 based on a control signal that is input from the control unit 110 or at a cycle that is set in advance.

The position detection unit 423 exchanges a wireless signal of a wireless LAN (including WiFi) in a 2.4 GHz band or 5 GHz band or another wireless signal and detects the position of the control device 10B with reference to a position of a base station (not shown) or an access point (not shown) that is located in the periphery. The position detection unit 420 outputs information of the position that is detected by the position detection unit 423 to the control unit 110 based on a control signal that is input from the control unit 110 or a cycle that is set in advance.

The IR camera 431 is a digital camera that includes a light receiving element that receives infrared light and creates captured image data based on a light receiving state of the light receiving element. The imaging unit 430 causes the IR camera 431 to execute imaging based on a control signal that is input from the control unit 110 or a cycle that is set in advance, and outputs the captured image data of the IR camera 431 to the control unit 110.

The illuminance sensor 432 is arranged at a position, at which the illuminance sensor is exposed to the front side, of the control device 10B, receives outside light, and outputs a detection value corresponding to the intensity of the received light. The imaging unit 430 outputs the detection value of the illuminance sensor 432 to the control unit 110 based on a control signal that is input from the control unit 110 or a cycle that is set in advance.

The heat detecting sensor 433 is arranged at a position, at which the heat detecting sensor 433 is exposed to the front surface, of the control device 10B, receives infrared light, and detects a temperature based on the intensity of the received infrared light. The imaging unit 430 outputs the detection value of the temperature that is detected by the heat detecting sensor 433 to the control unit 110 based on a control signal that is input from the control unit 110 or at a cycle that is set in advance.

The condition detection unit 440 detects body conditions of a user who uses the head-mounted display apparatus 100B. The body conditions of the user include so-called vital signs (a blood pressure, a pulse, a body temperature, and the like) and also include data that relates to body conditions and can be externally detected, as well as the vital signs. Detection values (detection results) in relation to the body conditions may be referred to as vital signs or can be referred to as biological body information, life information, or the like in a broader sense than the vital signs. According to the embodiment as an example, the condition detection unit 440 detects a body temperature, a sweating state, a heartbeat, and a blood pressure of the user and outputs the detection values as biological body information to the control unit 110.

The condition detection unit 440 includes a temperature sensor 441 that detects a body temperature by being brought into contact with the surface of the user body or in a non-contact manner, and outputs a detection value of the body temperature, which is obtained by the temperature sensor 441, to the control unit 110 based on a control signal that is input from the control unit 110 or at a cycle that is set in advance. The sweating sensor 442 detects a sweating state by being brought into contact with the surface of the user body or in the non-contact manner. The condition detection unit 440 outputs a detection value of the sweating sensor 442 to the control unit 110 based on a control signal that is input from the control unit 110 or at a cycle that is set in advance. The heartbeat sensor 443 is configured to detect beat while being in contact with the surface of the user body or is configured to detect beat by irradiating a vessel with light and detecting reflected light or transmitted light, and measures a pulse of the user. The condition detection unit 440 outputs a measurement value of the heartbeat sensor 443 to the control unit 110 based on a control signal that is input from the control unit 110 or at a cycle that is set in advance.

The blood pressure sensor 444 detects a blood pressure of the user, and the condition detection unit 440 outputs a detection value of the blood pressure sensor 444 to the control unit 110 based on a control signal that is input from the control unit 110 or at a cycle that is set in advance.

In a configuration in which the user wears the control device 10B such that the control device 10B is in contact with the user body, the condition detection unit 440 can be accommodated in the control device 10B. In addition, the condition detection unit 440 may be formed separately from the control device 10B. For example, the condition detection unit 440 may be accommodated in a wrist watch-shaped case (not shown), and the user may wear the case on their body. For example, one or more of the temperature sensor 441, the sweating sensor 442, the heartbeat sensor 443, and the blood pressure sensor 444 may be accommodated in a case (not shown), and the user may wear a plurality of cases on their body. In such a case, the respective separate components may be connected in a wired manner by using a cable or may be connected with a wireless communication link.

In this configuration, the control unit 110 can obtain data including detection results of the position detection unit 420, the imaging unit 430, and the condition detection unit 440.

The image display unit 20B includes a motion detection unit 450, an eye movement measurement unit 460, a visual measurement unit 470, a condition detection unit 480, and an input detection unit 490 as the configurations that are described above as the first sensor 161 and the second sensor 162 in the image display unit 20.

The motion detection unit 450 includes a nine-axis sensor 451 and a GPS 452. The nine-axis sensor 451 is a motion sensor that includes a three-axis acceleration sensor, a three-axis gyro sensor, and a three-axis geomagnetic sensor in the same manner as the sensor described above as the second sensor 162 (FIG. 3). The GPS 452 (second GPS receiving unit) is configured in the same manner as the sensor described above as the GPS 163 (FIG. 3). The motion detection unit 450 outputs information of the detection values of the nine-axis sensor 451 and information of a current position that is detected by the GPS 452 to the control unit 110 based on a control signal that is input from the control unit 110 or at a cycle that is set in advance.

The eye movement measurement unit 460 detects movement of eyeballs of the user. The eye movement measurement unit 460 includes an IR camera 461 that images the eyes of the user with infrared light and a myopotential sensor 462 that detects a potential of eye muscles. The IR camera 461 may be arranged inside each of the right optical image display unit 26 (FIG. 1) and the left optical image display unit 28 (FIG. 1). In addition, the user may wear the myopotential sensor 462 on their face. The eye movement measurement unit 460 outputs captured image data of the IR camera 461 and a detection value of the myopotential sensor 462 to the sub-control unit 150. In addition, the eye movement measurement unit 460 may output a processing result obtained by performing data processing of one of or both the captured image data of the IR camera 461 and the detection value of the myopotential sensor 462 to the sub-control unit 150.

The visual measurement unit 470 includes an IR camera 471 that captures an image with infrared light, a UV camera 472 that captures an image with ultraviolet light, a heat detecting sensor 473, and an illuminance sensor 474. The IR camera 471 is a digital camera that includes a light receiving element that receives infrared light and creates captured image data based on a light receiving state of the light receiving element. The visual measurement unit 470 causes the IR camera 471 to capture an image based on a control signal that is input from the sub-control unit 150 or at a cycle that is set in advance and outputs the captured image data of the IR camera 471 to the sub-control unit 150.

The heat detecting sensor 473 is arranged at a position, at which the heat detecting sensor 473 is exposed to the front surface, of the image display unit 20B, receives the infrared light, and detects a temperature based on the intensity of the received infrared light. The visual measurement unit 470 outputs a detection value of the temperature that is detected by the heat detecting sensor 473 to the sub-control unit 150 based on a control signal that is input from the sub-control unit 150 or at a cycle that is set in advance.

The illuminance sensor 474 is arranged at a position, at which the illuminance sensor 474 is exposed to the front surface, of the image display unit 20B, receives the outside light, and outputs a detection value corresponding to the intensity of the received light. The visual measurement unit 470 outputs a detection value of the illuminance sensor 432 to the sub-control unit 150 based on a control signal that is input from the sub-control unit 150 or at a cycle that is set in advance.

The condition detection unit 480 detects body conditions of the user who uses the head-mounted display apparatus 100B. The body conditions of the user include so-called vital signs (a blood pressure, a pulse, a body temperature, and the like) and also include data that relates to body conditions and can be externally detected, as well as the vital signs. Detection values (detection results) in relation to the body conditions may be referred to as vital signs or can be referred to as biological body information, life information, or the like in a broader sense than the vital signs. According to the embodiment as an example, the condition detection unit 480 detects a body temperature and a sweating state of the user and outputs the detection values as biological body information to the sub-control unit 150.

The condition detection unit 480 includes a temperature sensor 481 that detects a body temperature by being brought into contact with the surface of the user body or in a non-contact manner, and outputs a detection value of the body temperature, which is obtained by the temperature sensor 481, to the sub-control unit 150 based on a control signal that is input from the sub-control unit 150 or at a cycle that is set in advance. The sweating sensor 482 detects a sweating state by being brought into contact with the surface of the user body or in the non-contact manner. The condition detection unit 480 outputs a detection value of the sweating sensor 482 to the sub-control unit 150 based on a control signal that is input from the sub-control unit 150 or at a cycle that is set in advance.

The user wears the image display unit 20B on their head. The temperature sensor 481 and the sweating sensor 482 are arranged below the right holding unit 21 (FIG. 1) and the left holding unit 23 (FIG. 1), or the right optical image display unit 26 and the left optical image display unit 28 (FIG. 1), which are brought into contact with the head of the user, in the image display unit 20B, for example.

The input detection unit 490 includes a brain wave sensor 491 and a microphone 492. The brain wave sensor 491 detects a brain wave of the user who wears the head-mounted display apparatus 100B. The input detection unit 490 outputs a detection result of the brain wave, which is detected by the brain wave sensor 491, to the sub-control unit 150 based on a control signal that is input from the sub-control unit 150 or at a cycle that is set in advance. The microphone 492 may be provided separately from the microphone 63, or the microphone 63 may be used as the microphone 492. The input detection unit 490 outputs a detection result of the microphone 492 to the sub-control unit 150 based on a control signal that is input from the sub-control unit 150 or at a cycle that is set in advance.

With such a configuration, the sub-control unit 150 can obtain data including the detection results of the motion detection unit 450, the eye movement measurement unit 460, the visual measurement unit 470, the condition detection unit 480, and the input detection unit 490.

The control unit 110 in the control device 10B and the sub-control unit 150 in the image display unit 20B illustrated in FIG. 11 can execute the operations illustrated in FIGS. 4A to 6B described in the first embodiment and the operations illustrated in FIGS. 7A, 7B, 10A, and 10B described in the second embodiment. With such a configuration, the control unit 110 can efficiently obtain the detection results of the sensors by exchanging data between the control device 10B and the image display unit 20B on which a large number of sensors are mounted. In addition, it is possible to achieve the same effects as those of the head-mounted display apparatus 100 described above in the first and second embodiments.

In addition, the control device 10B includes the GPS 421 that is connected to the control unit 110 and obtains time information based on a GPS signal. The control unit 110 can obtain the time information based on a radio wave from a satellite, which is received by the GPS 421, and obtain present time.

With such a configuration, the control device 10B and the image display unit 20B may be synchronized with each other based on the GPS signal. For example, the control unit 110 can obtain time information from the GPS 421, and the sub-control unit 150 can receive a radio wave from the satellite by using the GPS 163 and obtain the time information that is included in the received information. A communication start request may be transmitted from the control unit 110 to the sub-control unit 150 in Step S107 (FIGS. 7A and 7B), and the control unit 110 and the sub-control unit 150 may start counting the time with reference to the time information received by the GPS by using the communication start request as a trigger. In such a case, the control unit 110 and the sub-control unit 150 can be synchronized based on a global standard time.

### Fourth Embodiment

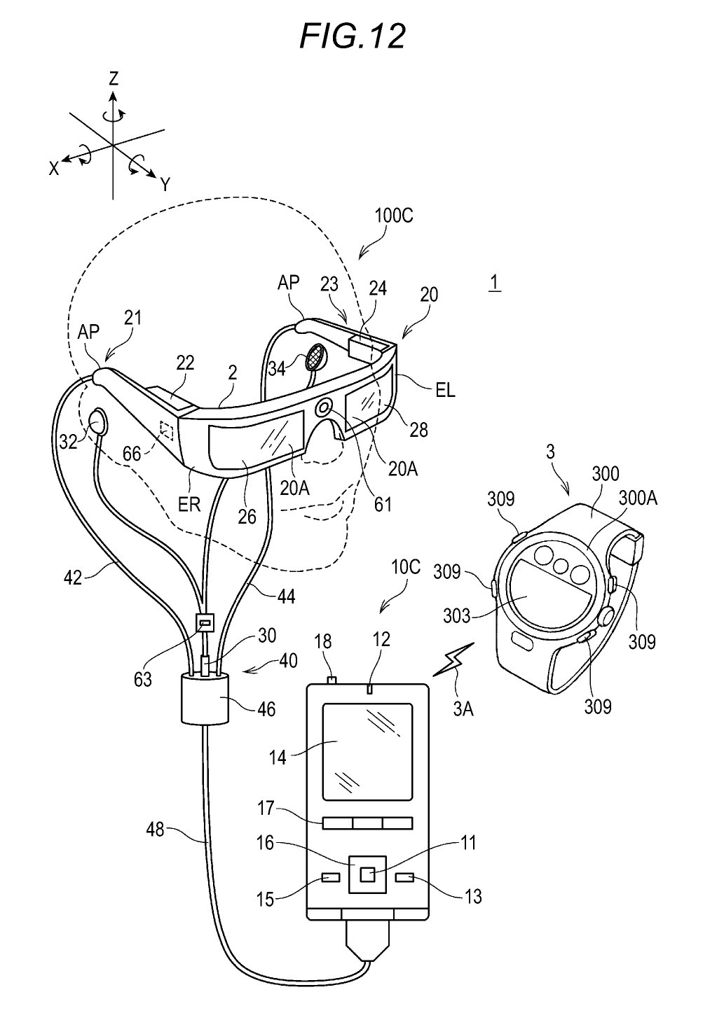

FIG. 12 is an explanatory diagram illustrating an appearance configuration of a display system 1 according to a fourth embodiment to which the invention is applied.

The display system 1 includes a head-mounted display apparatus 100C, an image display unit 20, and a body wearing device 3 that a user wears on their body. The body wearing device 3 is a so-called wearable device that the user can wear on their body, and in this embodiment, the body wearing device 3 has a wrist watch-like shape with which the user wears the body wearing device 3 on their wrist.

The head-mounted display apparatus 100C is configured in the same manner as in the first embodiment and includes a control device 10C formed by adding an infrared communication unit 131 to the control device 10 (FIG. 3) as will be described later. The control device 10C and the image display unit 20 have the same configurations as those in the first embodiment other than that the control device 10C is provided with the infrared communication unit 131. Therefore, the same reference numerals will be given to the same components as those in the first embodiment, and the descriptions thereof will be omitted.

The body wearing device 3 includes a band unit 300 with a shape that is similar to that of a band of a wrist watch. The band unit 300 includes a fixing unit such as a buckle, which is not shown in the drawing, and can be wound around and fixed around a forearm of the user, for example. A case unit 300A with a substantially disk shape is formed at a position corresponding to a dial phase of the wrist watch in the band unit 300 of the body wearing device 3. An LCD 303 and a plurality of buttons 309 are formed in the case unit 300A.

The LCD 303 is a liquid crystal display (LCD) that displays characters or images. The buttons 309 are press button-type switches that are arranged outside the case unit 300A.

Present time and information that indicates an operation state of the body wearing device 3 are displayed on the LCD 303.

The buttons 309 function as operation elements that are used by the user to operate the body wearing device 3.

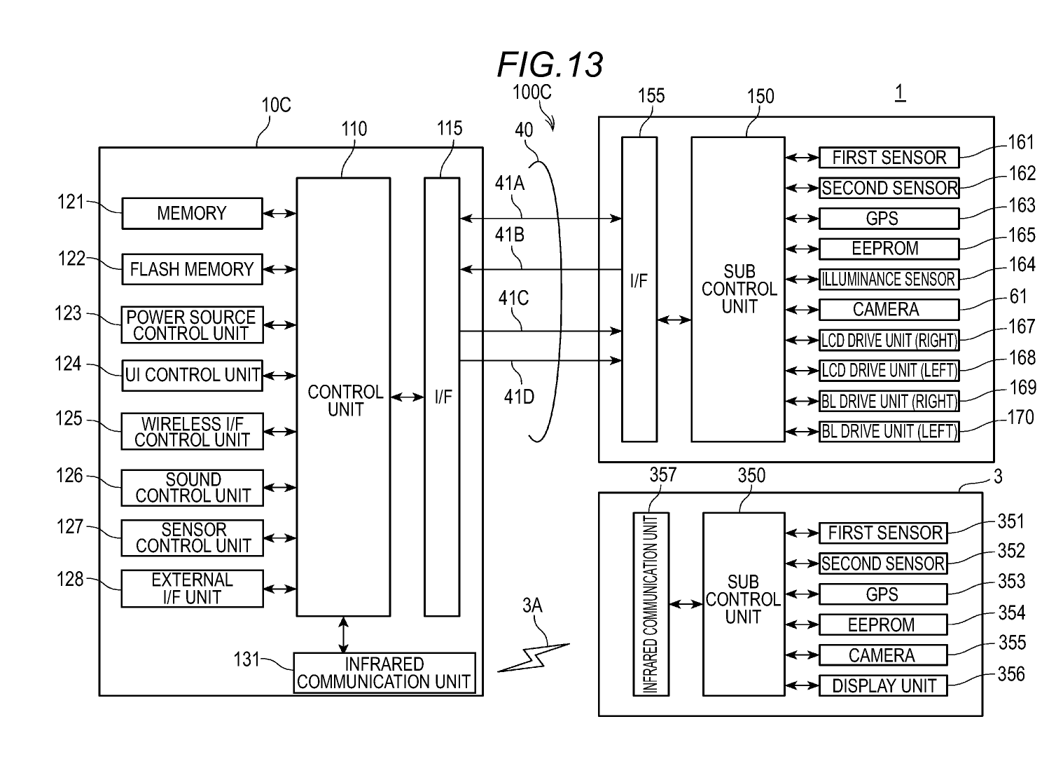

FIG. 13 is a functional block diagram of the respective components in the display system 1.

In the configuration illustrated in FIG. 13, the body wearing device 3 includes a sub-control unit 350. In addition, the body wearing device 3 includes a first sensor 351, a second sensor 352, a GPS 353, an EEPROM 354, a camera 355, a display unit 356 and an infrared communication unit 357 that are connected to the sub-control unit 350.

The control device 10C includes an infrared communication unit 131 in addition to the configuration of the control device 10 (FIG. 3).

The infrared communication unit 357 and the infrared communication unit 131 include infrared LEDs (not shown) that emit infrared light and light-receiving elements (not shown) that receive the infrared light and mutually exchange infrared signals. In doing so, the control device 10C and the body wearing device 3 form an infrared communication link 3A, and the control unit 110 and the sub-control unit 350 can exchange control data and data including detection values of the sensors via the infrared communication link 3A.

The first sensor 351 corresponds to the first sensor 161 provided in the image display unit 20. The second sensor 352 corresponds to the second sensor 162, and the GPS 353 corresponds to the GPS 163. The EEPROM 354 corresponds to the EEPROM 165, and the camera 355 corresponds to the camera 61. The sub-control unit 350 can execute the same operation as that of the sub-control unit 150 obtaining detection values of the respective sensors including the first sensor 161, the second sensor 162, the GPS 163, the illuminance sensor 164, and the camera 61.

The EEPROM 354 stores data to be processed by the sub-control unit 350 in a non-volatile manner in the same manner as the EEPROM 165.

The display unit 356 is connected to the LCD 303 (FIG. 12) and is controlled by the sub-control unit 350 to cause the LCD 303 to display present time and detection values of the various sensors.

The sub-control unit 350 obtains detection values of the first sensor 351, the second sensor 352, the GPS 353, and the camera 355 at predetermined sampling cycles and transmits data including the obtained detection values to the control unit 110. The operations correspond to the operations in FIGS. 4A to 6B described above in the first embodiment and the operations in FIGS. 7A, 7B, 10A, and 10B in the second embodiment.

In addition, the EEPROM 354 may store the same information as the sensor information 165a (FIG. 8) as information related to the respective sensors that are provided in the body wearing device 3.

The control unit 110 and the sub-control unit 350 execute the operations illustrated in FIGS. 7A and 7B, for example. In such a case, the sub-control unit 350 operates in the same manner as the sub-control unit 150.

The control unit 110 exchanges data with the sub-control unit 150 that is provided in the image display unit 20 as described above and obtains detection values of the various sensors that are connected to the sub-control unit 150. In addition, the control unit 110 can set sampling cycles at which the sub-control unit 150 obtains the detection values of the respective sensors and a cycle at which the sub-control unit 150 transmits the data.

In addition, the control unit 110 can cause the sub-control unit 350 that is provided in the body wearing device 3 to obtain the detection values of the respective sensors in the body wearing device 3 in the same manner as the sub-control unit 150 and transmit data including the obtained detection values. The sub-control unit 350 receives control data that is transmitted by the control unit 110, initializes and activates the first sensor 351, the second sensor 352, the GPS 353, and the camera 355, and performs setting in relation to the sampling cycles and the like.

The sub-control unit 350 starts counting of a time code at timing at which a communication start request that is transmitted by the control unit 110 is received. In doing so, the control unit 110 and the sub-control unit 350 are synchronized with each other. The sub-control unit 350 obtains detection results of designated sensors at the sampling cycles that are set in accordance with designation by the control unit 110 and transmits data including the detection results to the control unit 110.

The control unit 110 transmits the communication start request to the sub-control unit 350 via the infrared communication link 3A. The communication start request is information of designating timing at which counting of the time code is started, and information related to the synchronization. It is possible to suppress a delay in relation to the exchange of the communication start request and to more precisely synchronize the control unit 110 and the sub-control unit 350 by exchanging the information related to the synchronization as an optical signal.

The effect can be achieved even by a configuration in which the control unit 110 and the sub-control unit 150 execute infrared communication, for example.

According to the display system 1 of the fourth embodiment, the control unit 110 can obtain the detection values of the respective sensors in the image display unit 20 and the detection values of the respective sensors provided in the body wearing device 3. When the detection values of the large number of sensors are obtained, the sub-control unit 150 and the sub-control unit 350 obtain the detection values of the sensors at the sampling cycles designated by the control unit 110 and transmit the data at the timing designated by the control unit 110. Therefore, there is an advantage that it is possible to cause the control unit 110 to obtain and process data including the detection results of the large number of sensors while suppressing an increase in the burden on the control unit 110.

Here, the form of the data that is transmitted from the sub-control unit 150 to the control unit 110 and the form of the data that is transmitted from the sub-control unit 350 to the control unit 110 can be a frame format illustrated in FIG. 9, for example. In such a case, a sign or data with which it is possible to identify the sensors provided in the image display unit 20 and the sensors provided in the body wearing device 3 may be added to the sensor identifier. In addition, data indicating which of the sub-control unit 150 and the sub-control unit 350 a transmission source is may be included in the payload D13 or the header of the frame, separately from the sensor identifier and the sensor data. Alternatively, which of a frame transmitted by the sub-control unit 150 and a frame transmitted by the sub-control unit 350 the corresponding frame is can be specified by the sensor identifier or the sensor data.

The display system 1 is configured to be able to exchange data with the control unit 110. As an example of a device including sensors, a configuration including the body wearing device 3 as a wrist watch-like device was described. As another example of the device that the user wears on their body, a configuration in which the device can be attached to or accommodated in clothes of the user or a shape that is integrally formed with clothes, a cap, shoes, gloves, or the like is exemplified. In addition, the number of devices that can communicate with the control unit 110 is not limited, and a configuration is also applicable in which a new device is added to the control unit 110 that is used along with the sub-control unit 150 and communication is established therebetween.

Although the configuration according to the fourth embodiment in which the control device 10C and the body wearing device 3 exchanged control data and data including the detection values of the sensors via the infrared communication link 3A was exemplified, a connection state of the control device 10C and the body wearing device 3 is not limited thereto, and the control device 10C and the body wearing device 3 may be connected to each other by another communication mechanism. For example, the control device 10C and the body wearing device 3 may be connected by a wireless communication interface such as a wireless LAN (including WiFi (registered trademark)) or Bluetooth (registered trademark) or a wired communication interface such as a LAN or a USB.

In the second embodiment, the configuration in which the control unit 110 and the sub-control unit 150 synchronized the time codes by starting counting of the time codes in the synchronized manner was described. In the third embodiment, the configuration in which the control unit 110 and the sub-control unit 350 synchronized the counting of the time codes was described. In these configurations, there is a possibility that the synchronization deviates while the time codes are counted in a case in which time per one count differs between the control unit 110 and the sub-control unit 150. The control unit 110 and the sub-control unit 350 have the same possibility. Thus, a configuration is applicable in which the counting is synchronized in advance between the control unit 110 and the sub-control unit 150 and/or between the control unit 110 and the sub-control unit 350.

Specifically, a method of performing setting on one of or both the control unit 110 and the sub-control unit 150 such that time required for one count by the control unit 110 becomes the same as the time required for one count by the sub-control unit 150 is exemplified.

Another method in which notification indicating the time required for one count by the sub-control unit 150 is provided from the sub-control unit 150 to the control unit 110 or is obtained by the control unit 110 is exemplified. According to the method, it is possible to maintain the synchronization by the control unit 110 calculating a count value of the time code of the sub-control unit 150 from a count value of the time code of the control unit 110 or converting a time code included in data that is received from the sub-control unit 150 into a time code that is counted by the control unit 110.

It is a matter of course that these methods can be executed between the control unit 110 and the sub-control unit 350.

In doing so, it is possible to count the time codes in the synchronized manner between the control unit 110 and the sub-control unit 150 and/or between the control unit 110 and the sub-control unit 350 even in the case in which time required for one count differs from each other.

The invention is not limited to the configurations of the aforementioned respective embodiments and can be performed in various manners without departing from the gist thereof.

For example, the configuration in which the EEPROM 165 stores the sensor information 165a and the sub-control unit 150 refers to the sensor information 165a and transmits the information related to the sensors to the control unit 110 was described in the aforementioned respective embodiments. The invention is not limited thereto, and an external device with which the control unit 110 or the sub-control unit 150 can communicate may store the information related to the sensors. The external device is not limited to a device that can communicate with the control unit 110 or the sub-control unit 150 via a communication link in the system, such as WiFi or a LAN, and a device that can be connected via an open network such as the Internet can also be used. In such a case, the control unit 110 or the sub-control unit 150 may communicate with the external device via the communication link and obtain the information related to the sensors.

With such a configuration, information for specifying a device that is provided with the sub-control unit 150 may be added to or included in the sensor information 165a that is stored in the external device. As the information for specifying the device that is provided with the sub-control unit 150, a vendor, a model code, a model name, a name, a serial code, and the like of the device are exemplified. In such a case, the control unit 110 or the sub-control unit 150 can communicate with the external device via the communication link and search or designate and obtain the sensor information 165a corresponding to the device that is provided with the sub-control unit 150. For example, the control unit 110 can obtain or identify information for specifying the control device 10 as the device that is provided with the sub-control unit 150 and obtain the sensor information 165a from the external device based on the information. The same is true for the body wearing device 3 that is provided with the sub-control unit 350. The information for specifying the body wearing device 3 may be added to or included in the sensor information 165a that is stored in the external device. In such a case, the control unit 110 can communicate with the external device via the communication link and search or designate and obtain the sensor information 165a corresponding to the body wearing device 3. The control unit 110 can obtain the sensor information 165a corresponding to the body wearing device 3 from the external device by detecting the model number, the model code, or the name of the body wearing device 3.

For example, an image display unit based on another scheme such as an image display unit that the user wears as a cap may be employed instead of the image display units 20 and 20B as long as the image display unit includes a display unit that displays an image for the left eye of the user and a display unit that displays an image for the right eye of the user. The display apparatus according to the invention may be configured as a head-mounted display that is mounted on a vehicle such as a car or an airplane, for example. Alternatively, the display apparatus according to the invention may be configured as a head-mounted display that is built in a body protection tool such as a helmet, for example. In such a case, a portion for positioning relative to the user body and a portion that is positioned relative to the portion can be made to serve as wearing portions.

Notebook computers, tablet computers, or desktop computers may be used as the control devices 10, 10B, and 10C. Alternatively, mobile electronic devices such as game machines, mobile phones, smart phones, or mobile media players and other dedicated devices may be used as the control devices 10, 10B, and 10C.

As a configuration of generating image light in the image display units 20 and 20B, a configuration including an organic electro-luminescence (organic EL) display and an organic EL control unit may be employed. As the configuration of generating the image light, Liquid Crystal on Silicon (LCoS; registered trademark), a digital micromirror device, or the like may be used.

As an optical system that guides the image light to the eyes of the user, a configuration including an optical member that transmits outside light that is incident on the device from the outside and causing the outside light to be incident on the eyes of the user along with the image light can be employed. An optical member that is positioned in front of the eyes of the user and overlaps a part or an entirety of the eyesight of the user may be used. Furthermore, a scanning-type optical system that scans laser light, for example, and forms image light may be employed. The optical system is not limited to the configuration in which the image light is guided inside the optical member, and an optical system that has only a function of refracting and/or reflecting and guiding the image light toward the eyes of the user may be used.

For example, it is possible to apply the invention to a laser retina projection-type head-mounted display. That is, a configuration in which the user is made to visually recognize an image by providing a laser light source and an optical system that guides the laser light to the eyes of the user in a light emitting unit, causing the laser light to be incident on the eyes of the user, scanning the retinas, and forming the image on the retinas may be employed.

In addition, it is possible to apply the invention to a display apparatus that employs a scanning optical system using an MEMS mirror and uses an MEMS display technology. That is, a signal light forming unit, a scanning optical system that includes an MEMS mirror for scanning light emitted by the signal light forming unit, and an optical member in which a virtual image is formed by light scanned by the scanning optical system may be provided as the light emitting unit. With such a configuration, the light emitted by the signal light forming unit is reflected by the MEMS mirror, is then incident on the optical member, is guided inside the optical member, and reaches a virtual image formation plane. The virtual image is formed on the virtual image formation plane by the MEMS mirror scanning the light, and the user recognizes the image by catching the virtual image with the eyes. The optical components in this case may guide the light through reflection caused a plurality of times as the right light guiding plate 261 and the left light guiding plate 262 in the aforementioned embodiments, or a half mirror surface may also be used.

Furthermore, the optical elements according to the invention are not limited to the right light guiding plate 261 and the left light guiding plate 262 that include the half mirrors 261A and 262A, and any optical components may be used as long as the optical components cause the image light to be incident on the eyes of the user. Specifically, diffraction gratings, prisms, or holographic display units may be used.

In addition, at least a part of the respective functional blocks illustrated in FIGS. 3, 11, and 13 may be realized as hardware, a configuration that is realized by cooperation of hardware and software is also applicable, and the invention is not limited to the configuration in which independent hardware resources are arranged as illustrated in FIGS. 3, 11, and 13. The respective functional units illustrated in FIGS. 3, 11, and 13 are not limited to the exemplary configuration of the microprocessors and the ICs, and a configuration in which a plurality of functional units are mounted on a larger-scaled integrated circuit is also applicable, or another form such as SoC may be employed. The configurations formed in the control devices 10 and 10B may be formed in the image display units 20 and 20B in the overlapped manner.

The entire disclosure of Japanese Patent Application No.:2014-247963, filed Dec. 8, 2014 and 2015-213656, filed Oct. 30, 2015 are expressly incorporated by reference herein.

What is claimed is:

1. A display apparatus comprising:
a display unit;
a plurality of sensors;
a first control unit that controls the display apparatus; and
a second control unit that is connected to the plurality of sensors and transmits data including detection results of the plurality of sensors to the first control unit.

2. The display apparatus according to claim 1,
wherein the second control unit collectively controls the plurality of sensors based on control by the first control unit.

3. The display apparatus according to claim 1,
wherein the second control unit obtains the detection results of the plurality of sensors at a plurality of different sampling cycles.

4. The display apparatus according to claim 3,
wherein the second control unit obtains the detection results of the plurality of sensors at a first sampling cycle and a second sampling cycle that is longer than the first sampling cycle, and transmits data including the detection results of the sensors, which are obtained at the first sampling cycle, and the detection results of the sensors, which are obtained at the second sampling cycle, to the first control unit.

5. The display apparatus according to claim 4,
wherein the second control unit is able to transmit the data including the detection results of the sensors to the first control unit in any of a first transmission format corresponding to the first sampling cycle and a second transmission format corresponding to the second sampling cycle.

6. The display apparatus according to claim 5,
wherein the second control unit selects any of the first transmission format and the second transmission format and transmits the data including the detection results of the sensors based on a sampling cycle that is requested by the first control unit.

7. The display apparatus according to claim 1,
wherein between the first control unit and the second control unit, transmission synchronization processing of synchronizing timing at which the second control unit transmits the data to the first control unit and setting of the data to be transmitted from the second control unit to the first control unit are performed.

8. The display apparatus according to claim 7, further comprising:
a sensor information storage unit that is connected to the second control unit and stores information related to the sensors that are connected to the second control unit,
wherein the first control unit sets the data to be transmitted by the second control unit based on the information that is stored in the sensor information storage unit.

9. The display apparatus according to claim 8,
wherein the sensor information storage unit stores information including sensor identifiers for identifying the sensors and sampling cycles at which the detection results of the sensors are obtained in association with the sensors.

10. The display apparatus according to claim 8,
wherein the sensor information storage unit stores information that indicates processing to be executed by the second control unit in association with the sensors.

11. The display apparatus according to claim 1,
wherein the first control unit transmits a control signal to the second control unit, and
wherein the second control unit initializes the sensors that are connected to the second control unit when the second control unit receives a control signal for instructing initialization from the first control unit.

12. The display apparatus according to claim 11,
wherein the second control unit executes synchronization processing with the first control unit when the second control unit receives the control signal for instructing initialization from the first control unit and initializes the sensors, and transmits the detection results of the sensors, which are obtained later, with data of detection time to the first control unit.

13. The display apparatus according to claim 11, further comprising:
a transmission unit that is connected to the first control unit and transmits the control signal as an optical signal; and
a receiving unit that is connected to the second control unit and receives the optical signal that is transmitted by the transmission unit.

14. The display apparatus according to claim 11, further comprising:
a first GPS receiving unit that is connected to the first control unit and obtains time information based on a GPS signal; and
a second GPS receiving unit that is connected to the second control unit and obtains time information based on a GPS signal,
wherein the first control unit and the second control unit execute synchronization processing based on the time information that is respectively obtained by the first GPS receiving unit and the second GPS receiving unit.

15. The display apparatus according to claim 11,
wherein the second control unit initializes the sensors that are connected to the second control unit when the second control unit receives the control signal for requesting setting update from the first control unit.

16. The display apparatus according to claim 15,
wherein in the synchronization processing, the first control unit transmits a synchronization signal to the second control unit at a predetermined timing, and the second control unit performs the synchronization based on the synchronization signal that is transmitted by the first control unit.

17. The display apparatus according to claim 15,
wherein after the execution of the synchronization processing, the first control unit and the second control unit respectively execute counting of time codes, and
wherein the second control unit transmits the data that is obtained by adding the time codes indicating acquisition time to the obtained results of the detection when the second control unit obtains the detection results of the sensors.

18. The display apparatus according to claim 17,
wherein the second control unit creates the data by embedding the time codes indicating the acquisition time in the data of the obtained results of the detection when the second control unit obtains the detection results of the sensors or adding the time code to the results of the detection, and transmits the data.

19. The display apparatus according to claim 1,
wherein the second control unit executes predetermined processing that is set in advance based on the detection results of the sensors when the second control unit receives a command from the first control unit.

20. The display apparatus according to claim 19,
wherein the second control unit executes, as the predetermined processing, processing of changing a display state of the display unit in accordance with an environment of the display unit based on the detection results of the sensors.

21. The display apparatus according to claim 19,
wherein the second control unit is connected to a setting data storage unit that stores setting data and executes the predetermined processing by using the setting data that is stored in the setting data storage unit.

22. The display apparatus according to claim 1,
wherein the second control unit holds the results of the detection obtained from the sensors until the results of the detection are transmitted to the first control unit.

23. The display apparatus according to claim 1,
wherein the second control unit executes, based on a detection result of any of the sensors, processing on detection results of the other sensors, and transmits the results of the detection after the processing to the first control unit.

24. The display apparatus according to claim 1, further comprising:
a first main body that includes the first control unit; and
a second main body that includes the second control unit and the display unit,
wherein the second control unit is connected to the plurality of sensors that are provided in the second main body,
wherein the first main body is provided with a sensor, and the sensor provided in the first main body is connected to the first control unit, and
wherein the first control unit calculates characteristic values based on detection results and positions of the sensors in the second main body and a detection result and a position of the sensor in the first main body.

25. The display apparatus according to claim 1, further comprising:
a first main body that includes the first control unit and the display unit; and
a second main body that includes the second control unit,
wherein the second control unit is connected to the plurality of sensors that are provided in the second main body,
wherein the first main body is provided with a sensor, and the sensor that is provided in the first main body is connected to the first control unit, and
wherein the first control unit performs control based on detection results of the sensor in the first main body and the sensors in the second main body.

26. A method of controlling a display apparatus comprising:
controlling a display apparatus that is provided with a display unit, a plurality of sensors, a first control unit, and a second control unit;
causing the second control unit that is connected to the plurality of sensors to collectively control the plurality of sensors; and
transmitting data including detection results of the plurality of sensors to the first control unit that controls the display apparatus.
